(19) United States
(12) Patent Application Publication
(10) Pub. No.: US 2024/0066401 A1
(43) Pub. Date: Feb. 29, 2024

(54) Dynamic Asynchronous Choice System for Multiplayer Interactive Applications

(71) Applicant: Magic DAYW Ltd., Uetikon Am See (CH)

(72) Inventor: Christian Keller, Zufikon (CH)

(21) Appl. No.: 17/894,443

(22) Filed: Aug. 24, 2022

(51) Int. Cl. A63F 13/47; A63F 13/35

(52) U.S. Cl. CPC A63F 13/47; A63F 13/35

(57) ABSTRACT

Methods and systems for providing a dynamic asynchronous choice system (DAX) for a plurality of different user computing devices are described herein. A first series of prompts may be generated and provided to a first user computing device as part of a first scene in a multiplayer interactive application. Based on a first set of responses received in response to that first series of prompts, a second series of prompts may be generated, the first scene might be modified, and the modified first scene might be provided to a second user computing device along with the second series of prompts. A second set of responses may be received in response to that second series of prompts. Based on the first set of responses and the second set of responses, a second scene may be selected and provided to the first user computing device and the second user computing device.

### FIELD

Aspects described herein generally relate to networked interactive computer applications such as online multiplayer videogames, client-server architectures, and hardware and software related thereto. More specifically, one or more aspects describe herein provide for a dynamic asynchronous choice system (DAX) for a plurality of different user computing devices executing a multiplayer interactive application.

### BACKGROUND

Multiplayer interactive computer applications, such as online multiplayer videogames, have become incredibly popular across the world. For example, many Massively Multiplayer Online Role-Playing Games (“MMORPGs”) and First-Person Shooter (“FPS”) games can serve millions of different users. These games often allow players to explore virtual two- and/or three-dimensional worlds, interact with other players, improve their in-game character(s), and the like.

One regular limitation with multiplayer interactive applications is that they are often limited in their ability to provide truly interactive stories for users. For example, while many MMORPGs have in-game cutscenes that tell various story elements, these cutscenes are generally the same for every user. Some of those MMORPGs have sought to remediate this one-size-fits-all storytelling approach in a number of ways. For example, the video game Final Fantasy XIV developed by Square Enix Holdings Co., Ltd. of Tokyo, Japan, sometimes renders a player's in-game character into cutscenes, though the cutscenes otherwise remain the same for all players. As another example, the game Star Wars: The Old Republic developed by Electronic Arts of Redwood City, CA allows a group of up to four users to vote on dialogue options in-game, then relies on a random dice roll to select from the voted-on options. As another example, the strategy game Civilization IV by Firaxis Games, Inc. of Baltimore, MD allows players to play asynchronously via e-mail, such that players might make in-game decisions at different times. With that said, multiplayer interactive applications generally do not have truly interactive stories, particularly in comparison to their offline counterparts.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards providing a dynamic asynchronous choice system (DAX) for a plurality of different user computing devices executing a multiplayer interactive application. The system is asynchronous in that a first user might be provided, in a multiplayer interactive application executing on their user device, one or more prompts for a scene during a first time period, then a second user might be provided, in the multiplayer interactive application executing on their own user device, one or more different prompts for the same scene during a subsequent time period. As part of this process, the same scene might be modified based on decisions made by the first user, such that the second user might be provided a modified version of the same scene as compared to the first user. Later, and based on responses to prompts from both the first user and the second user, a different scene may be selected from a plurality of different scene options. In this manner, the decisions made by the users—which might be for the same scene, albeit from different perspectives and/or involving different prompts/questions—might be used to select a later story element (e.g., a subsequent cutscene, set of options, etc.) from a plurality of story elements.

As will be described in further detail below, a server may be configured to provide a dynamic asynchronous choice system (DAX) for a plurality of different user computing devices executing a multiplayer interactive application. The server may generate, based on a gameplay template that defines a plurality of different scenes based on choices made by users of the multiplayer interactive application, a first series of prompts corresponding to a first scene in the multiplayer interactive application. The server may provide, to a first user computing device of the plurality of different user computing devices executing the multiplayer interactive application and via a network, the first series of prompts. That first user computing device may be configured to provide each of the first series of prompts to the first user computing device as part of the first scene. The server may receive, from the first user computing device and via the network, a first set of responses corresponding to the first series of prompts. After receiving the first set of responses, the server may generate, based on the first set of responses and based on the gameplay template, a second series of prompts corresponding to the first scene in the multiplayer interactive application. The second series of prompts may comprise at least one prompt different from the first series of prompts. The server may provide, to a second user computing device executing the multiplayer interactive application and via the network, the second series of prompts. As part of this process, the server may modify, based on the first set of responses, display of at least a portion of the first scene such that the first scene indicates at least one choice made by the first user. For example, the server may render, in an environment in the multiplayer interactive application, a representation of the first user, and that representation of the first user may be based on the first set of responses. The second user computing device may be configured to provide each of the second series of prompts to a second user as part of the first scene. The server may receive, from the second user computing device and via the network, a second set of responses corresponding to the second series of prompts. The server may select, from the plurality of different scenes defined by the gameplay template and based on the first set of responses and the second set of responses, a second scene. As part of this process, the server may compare one or more conditions, specified by the gameplay template and corresponding to the second scene, to at least a portion of the first set of responses and the second set of responses. Then, the server may provide, to the first user computing device and the second user computing device and via the network, data corresponding to the second scene. As part of this process, the server may modify, based on the first set of responses, display of at least a portion of the second scene such that the first scene indicates at least one choice made by the first user and at least one second choice made by the second user. The first user computing device and/or the second user computing device may be configured to provide, in the multiplayer interactive application, the second scene.

The prompts described above may comprise options in a user interface. For example, the server may cause a first user computing device to provide, in a user interface provided by the multiplayer interactive application executing on the first user computing device, one or more selectable options corresponding to the first series of prompts. That said, the responses described above need not be selections of options in a user interface. For example, as part of receiving the first set of responses, the server may receive activity data corresponding to one or more virtual actions performed, in the multiplayer interactive application, by a user-controllable playable character associated with the first user computing device and then process the activity data to identify the first set of responses.

After a first user responds to one or more first prompts but before a second user responds to one or more second prompts, the first user might be prompted to wait for the second user in various ways. For example, the server may send, to the first user computing device and via the network, a wait command configured to cause display, in the multiplayer interactive application executing on the first user computing device, a notification that a user of the first user computing device should wait on a second user of the second user computing device.

This system may be integrated with a spectator system, which might allow others to view activity in the multiplayer interactive application, react to such activity, and—based on those reactions—influence decision-making in the multiplayer interactive application. For example, various spectators may watch, but not participate in, activity in the multiplayer interactive application using one or more spectator computing devices. The server may receive, from one or more spectator computing devices and via the network, feedback data that indicates one or more reactions, by one or more users of the one or more spectator computing devices, to the first scene. In such a circumstance, generating the second series of prompts may be further based on the feedback data. The server may also provide, to the one or more spectator computing devices and via the network, graphical data corresponding to the second scene. That graphical data may comprise one or more frames depicting an environment in the multiplayer interactive application. Those one or more frames may be captured from a camera perspective, in the environment, that is based on the feedback data.

Non-player characters in the multiplayer interactive application might be able to influence how scenes are carried out. In this manner, the multiplayer interactive application might be configured with a bias towards certain story results. For instance, the server may determine, based on the gameplay template, a third set of responses corresponding to a non-player character in the multiplayer interactive application. The server may be configured to generate the second series of prompts further based on that third set of responses.

The above process may involve weighting different input (e.g., different user responses, spectator feedback, and/or non-playable character influence). For example, the server may weigh the first set of responses based on a first role associated with the first user computing device. The server may additionally and/or alternatively weigh the second set of responses based on a second rule associated with the second user computing device. The server may additionally and/or alternatively compare the weighted first set of responses and the weighted second set of responses. The second scene might be selected based on such a comparison.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts a computer architecture, including server(s), user device(s), and spectator device(s), for a multiplayer interactive application.

FIG. 4 is a flow chart with steps depicting how a scene might be provided to two different users, with one user receiving a modified version of the same scene based on responses to prompts in that scene made by a previous user, and with a subsequent scene selected for both users based on the responses made by both users.

FIG. 5 is a flow chart with steps for using a gameplay template to provide asynchronous prompts to users as part of the same scene, then selecting a subsequent scene based on responses from those users.

FIG. 6 depicts a gameplay template that shows how choices made by users, spectators, and non-playable characters (NPCs) might affect the choice of subsequent scenes based on one or more conditions for those subsequent scenes.

FIG. 7 shows examples of different prompts for different users and spectators.

FIG. 8 is a flow chart with steps for providing an opportunity for a collective decision in a story.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards implementing a dynamic asynchronous choice system (DAX) for multiplayer interactive applications, such as multiplayer online video games. Multiplayer interactive applications do not provide truly interactive asynchronous storytelling to multiple users on different user computing devices due to various technological and logistical limitations inherent in the act of providing those same multiplayer interactive applications. That said, users often want to engage with multiplayer interactive applications whenever they have a moment of time, as it can be difficult to ensure that other users are available (and willing to engage with the multiplayer interactive applications) at the same time due to busy schedules and time zone differences. The aspects described herein address this issue through a process whereby a server might provide an interactive scene to different user computing devices at different times (e.g., asynchronously, such as serially), but also in a manner where, if desired, the scene provided to different users is modified based on decisions by past users (e.g., such that users later in the sequence experience the same scene differently than previous users). This allows users to enjoy a multiplayer interactive application whenever they wish, while still giving those users agency in a multiplayer story and allowing those users to have a direct effect on the experience of other users. Moreover, based on the decisions made by all applicable users (and, if desired, spectators and non-playable characters), subsequent scenes might be selected and/or modified. In this manner, the multiplayer interactive application might provide different experiences to different users, and those different users might be able to enjoy widely different storytelling experiences, all without compromising key aspects of the client-server relationship of the multiplayer interactive application.

As one simplified example of how this process might work from the perspective of end users, assume, for instance, that the multiplayer interactive application is an MMORPG implementing the dynamic asynchronous choice system (DAX) described herein. Four friends might play that MMORPG as part of a party of adventurers, and those four friends might be watched by various spectators (e.g., other friends watching on an online game streaming service, such as the TWITCH™ live streaming service by Amazon.com, Inc. of Seattle, WA). As part of that experience, the players might all collectively experience a first scene in a town adventure's guild differently. During that first scene, a first player might be provided various prompts, such as being able to choose whether to interact with a bartender or accept a hunting quest. Based on what the first player chooses to do in that first scene, a second player might experience the same first scene in a different way. In other words, the first scene might be modified for subsequent users (including the second user) based on decisions made by the first user. For example, when the second player later experiences the same scene, the second player might see a representation of the first player interacting with the bartender, but might also have the option to, notwithstanding the first player's actions, try to accept the hunting quest. The second player might additionally and/or alternatively have different options as compared to the first player. For example, the second user might be able to pay the bartender for a hint, leave the town adventurer's guild, or the like. A similar asynchronous and/or sequential process might be performed for the other two users in the party. During this process (e.g., while the four users experience the scene), spectators might be provided the option to provide feedback, such as by voting whether they want to see the party talk to the bartender or accept the hunting quest. Moreover, during this process, non-playable characters might be configured to influence this process: for example, the MMORPG might be biased towards encouraging the players to talk with the bartender, such that this bias might break any ties between the players. Based on the users' responses, the spectators' feedback, and/or the non-playable characters' influence, a subsequent scene might be selected from a plurality of scenes. For example, the first user might talk to the bartender, and the second, third, and fourth users might agree to pay the bartender for a hint, such that a subsequent scene may be selected in a manner that allows the party to go on a quest provided by the bartender.

As another example of how this process might be implemented, aspects described herein might be implemented in a multiplayer dating simulation video game. A first player might be provided a first scene where they have the opportunity to confess their feelings to a second player. During that first scene, the first player might decide whether to confess their feelings. Moreover, during that first scene, a representation of the second player may be shown, and the representation of the second player might be used as part of facilitating in-game dialogue between the first player and the second player. Once the first player has decided whether or not to confess their feelings, the first player might be prompted to wait (e.g., to engage with other portions of the game). This might be referred to as a waitpoint. The first scene might then be modified to reflect whether or not the first player confessed their feelings. Then, the second player might be provided the modified second scene. For instance, the second player might be shown a representation of the first player confessing their feelings. The second player may then be provided opportunities to respond to the first player. Once the second player has provided one or more responses, both players' responses may be used to select a second scene. This might be referred to as a resolution phase, such that the decisions made by the players (e.g., whether the first player confessed, and/or whether the second player accepted such a confession) might be resolved in the selection of a second scene. For example, if the first player confesses and the second player rejects the confession, an awkward second scene might be selected. As another example, if the first player confesses and the second player accepts the confession, a second scene might be selected involving, for example, a jealous non-player character (e.g., a waitress at a restaurant, a jealous ex-girlfriend/ex-boyfriend, or the like).

Aspects described herein improve the functioning of computers by improving the way in which applications are implemented in a client-server environment where multiple clients interact with a multiplayer interactive application. The current limitations in the storytelling process of multiplayer interactive applications are largely due to the fact that the wide variety of users of those applications might make it difficult to implement realistic storytelling processes. For example, networking issues such as lag might make it difficult to ensure that all users are able to select the same choice(s) at the same time. As another example, because hundreds of different users might enjoy the same multiplayer interactive application at the same time, it can be difficult to determine ways to provide a truly different experience to each of those different users, especially when those experiences are provided at different times. The process described herein remedies these issues by uniquely structuring the relationship between a server and client devices in a manner which essentially renders the storytelling process into an asynchronous (e.g., serialized) flow that dynamically modifies itself as users make decisions, ensuring that each user in the sequence can enjoy an individualized storytelling experience that might nonetheless reflect the decision-making of other users.

Aspects described herein also relate to a unique configuration of computing devices, such as might be found in a client-server architecture. While some aspects disclosed herein might be implemented on commercially available computing devices (e.g., personal computers, game servers, video game consoles, handheld video game consoles, mobile phones such as smartphones, virtual reality devices, augmented reality devices, or the like), the unique configuration of those devices described herein, as well as the unique steps performed by those devices, are far beyond what is commercially available. For example, generic computing devices (e.g., servers) are in no way configured to provide asynchronous choice systems in multiplayer interactive applications in a manner that provides uniquely-tailored scenes to different users. In other words, one advantage of the aspects described herein is that it might uniquely configure some commercial computing devices to perform steps that those devices are not configured to perform otherwise.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

Computing Architecture

As a preliminary matter, this description will begin with various examples of computing devices and computing networks which might be used to implement various aspects of the present disclosure.

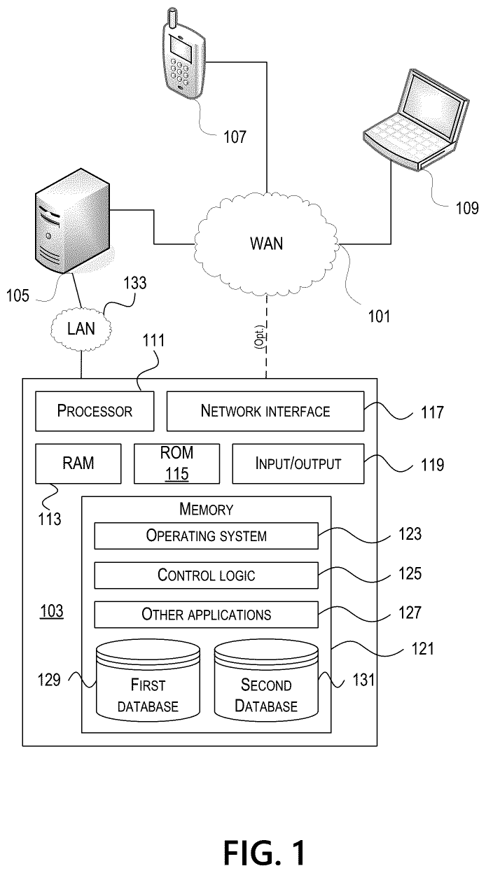

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes, such as the node 103, the node 105, the node 107, and the node 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. The network 101 is for illustration purposes and may be replaced with fewer or additional computer networks. A local area network 133 may have one or more of any known LAN topology and may use one or more of a variety of different protocols, such as Ethernet. Devices, such as the node 103, the node 105, the node 107, and the node 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, client computer 107, and client computer 109. The data server 103 provides overall access, control and administration of databases and control software for performing one or more illustrative aspects describe herein. The data server 103 may be connected to web server 105 through which users interact with and obtain data as requested. Alternatively, the data server 103 may act as a web server itself and be directly connected to the Internet. The data server 103 may be connected to web server 105 through the local area network 133, the wide area network 101 (e.g., the Internet), via direct or indirect connection, or via some other network. Users may interact with the data server 103 using remote computers, such as the client computer 107 and/or the client computer 109, e.g., using a web browser to connect to the data server 103 via one or more externally exposed web sites hosted by web server 105. The client computers, such as the client computer 107 and the client computer 109, may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by the web server 105 and the data server 103 may be combined on a single server.

Each component (e.g., the data server 103, the web server 105, the client computer 107, and the client computer 109) may be any type of known computer, server, or data processing device. The data server 103, e.g., may include a processor 111 controlling overall operation of the data server 103. The data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

The memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices (e.g., the data server 103, the web server 105, the client computer 107, and the client computer 109) may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

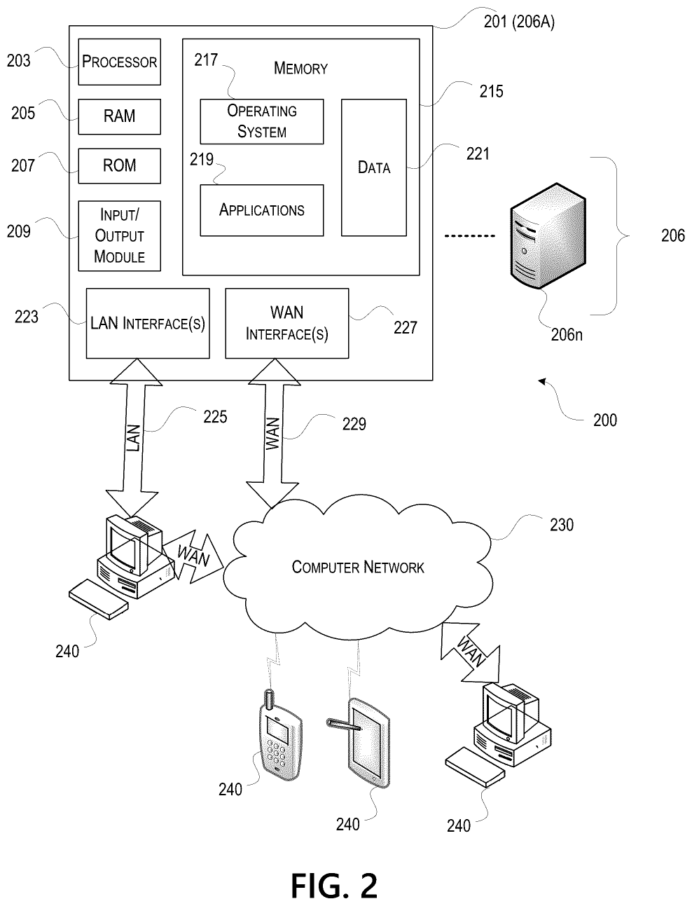

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. The computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

The computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. The computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

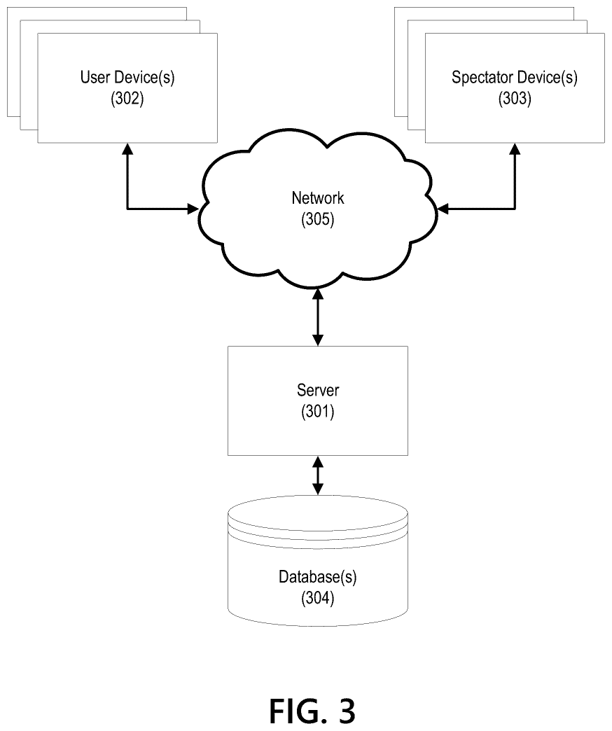

FIG. 3 shows a computer architecture, including a server 301 communicatively coupled, via a network 305, to one or more user devices 302 and one or more spectator devices 303. Such an architecture might be implemented as part of a multiplayer interactive application. The server 301 shown as being communicatively coupled to one or more databases 304. The server 301, the one or more user devices 302, and/or the one or more spectator devices 303 may comprise one or more computing devices. For example, the server 301 may comprise one or more processors and memory storing instructions that, when executed by the one or more processors, cause the performance of various steps. Additionally and/or alternatively, one or more non-transitory computer-readable media may store instructions that, when executed by one or more processors of the server 301, cause the performance of various steps. Additionally and/or alternatively, the server 301, the one or more user devices 302, and/or the one or more spectator devices 303 may be the same or similar as the devices identified above with respect to FIG. 1 or FIG. 2, such as the client 240, the one or more servers 206, any one of the devices 103, 105, 107, and 109, or the like.

The devices shown in FIG. 3 are illustrative, and the architecture depicted in FIG. 3 may be modified as desired. For example, while the server 301 is depicted as a single element for simplicity, multiple servers may be implemented (e.g., in a cloud server environment) to perform the role of the server 301. As another example, while the one or more spectator devices 303 are depicted in FIG. 3, in some instances there might not be a spectator functionality in a multiplayer interactive application, such that no spectator devices might exist in certain circumstances. As another example, though the one or more databases 304 are depicted as being communicatively coupled directly to the server 301, they might instead be communicatively coupled to the server 301 via the network 305. As another example, all of the elements depicted in FIG. 3 may be logical elements of a single computing device.

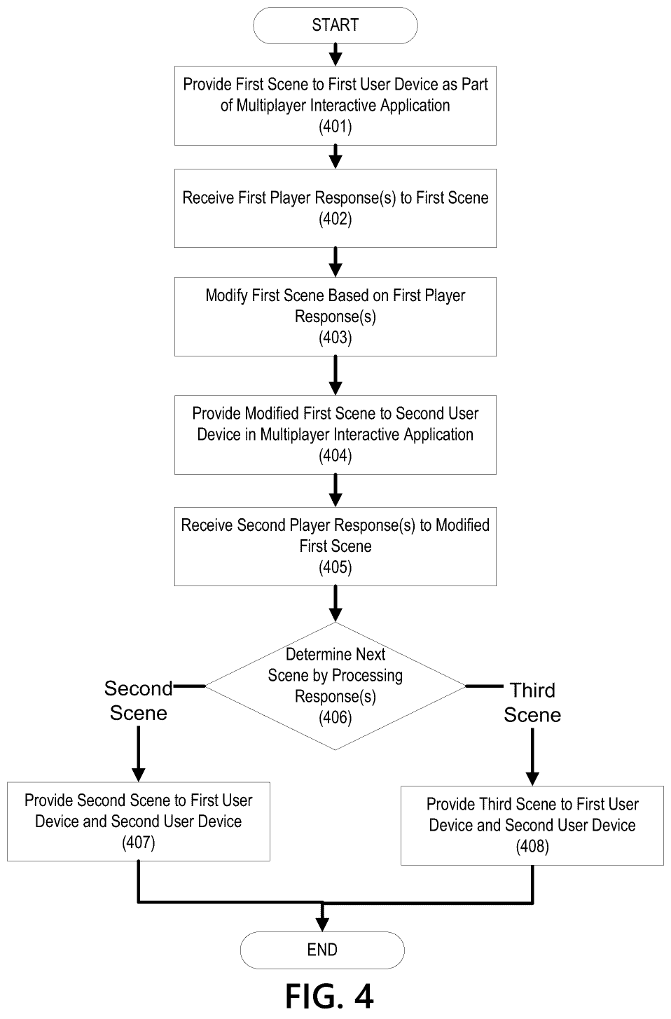

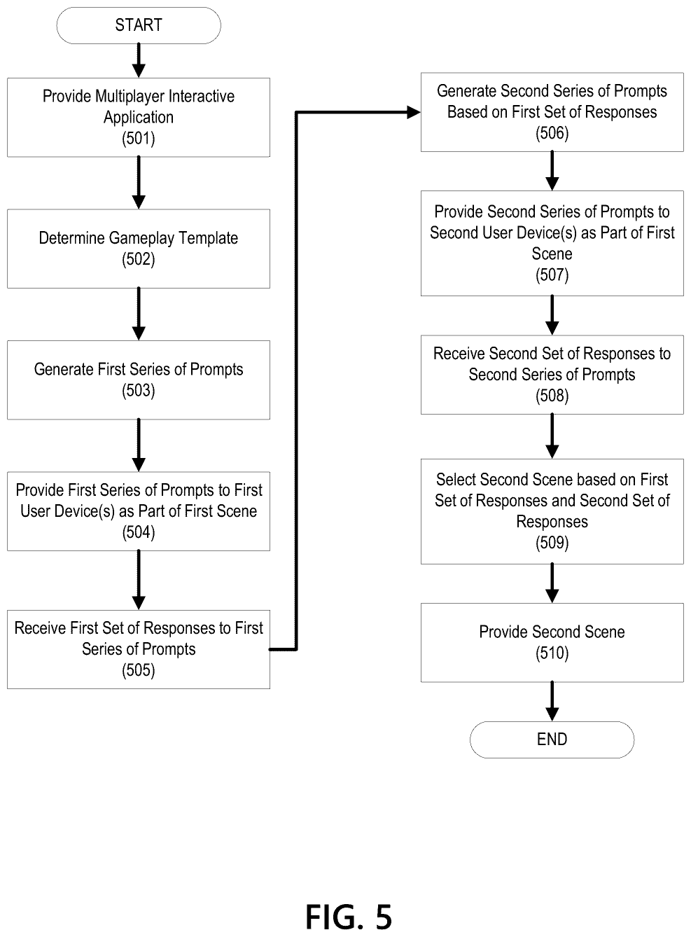

The server 301 may be configured to provide server functionality as part of a multiplayer interactive application to the one or more user devices 302 and/or the one or more spectator devices 303. For example, the server 301 may manage the multiplayer aspects of a multiplayer interactive application by connecting each of the one or more user devices 302 to one or more virtual worlds, implementing rules in those virtual worlds, providing matchmaking services, or the like. Thus, while the server 301 might be said to execute a multiplayer interactive application, such a process might involve exacting one or more applications which are configured to provide a server functionality for the multiplayer interactive application. As part of this process, the server 301 may store information, such as user account data, rules data, gameplay templates, and the like in the one or more databases 304. The server 301 may additionally and/or alternatively implement a dynamic asynchronous choice system (DAX) for multiplayer interactive applications, as will be described in more detail below with respect to FIG. 4 and FIG. 5.

The one or more user devices 302 may be one or more computing devices (e.g., smartphones, game consoles, personal computers, augmented reality devices, virtual reality devices) that may execute a multiplayer interactive application. As part of the execution of that multiplayer interactive application, the one or more user devices 302 may render a two- and/or three-dimensional environment (including, as desired, user interface(s)) on one or more display screens, receive user input, translate that user input into interactions in the two- and/or three-dimensional environment, receive and/or output text content (e.g., user chat commands, paragraphs of story), receive and/or output audio content, or the like. For example, as part of executing a multiplayer interactive application for an FPS game, the one or more user devices 302 may output a three-dimensional environment in which a user may, using user input, explore and use input commands (e.g., left click actions) to shoot a virtual weapon. As another example, as part of a multiplayer interactive application for a MMORPG, the one or more user devices 302 may output a two-dimensional environment in which a user may, using user input, move a game character around to interact with a virtual world. The one or more user devices 302 may communicate, e.g., via the network 305, with the server 301. Additionally and/or alternatively, the one or more user devices 302 may communicate with one another in a peer-to-peer relationship. For example, the one or more user devices 302 may communicate, via the network 305, with one another for the purposes of implementing text chat or voice chat, whereas the one or more user devices 302 may communicate with the server 301 as part of gameplay functionality (to, e.g., prevent users of the one or more user devices 302 from cheating through memory editing or the like).

The one or more spectator devices 303 may be capable of spectating one or more aspects of a multiplayer interactive application. The one or more spectator devices 303 may execute one or more applications which, when used, permit the one or more spectator devices 303 to observe activity in the multiplayer interactive application. The one or more spectator devices 303 may observe activity in the multiplayer interactive application in a variety of ways. For example, the one or more spectator devices 303 may themselves execute the multiplayer interactive application in a spectator mode, which allows those devices to connect to the server 301 and render a two- and/or three-dimensional environment which permits users of those devices to observe the actions associated with the one or more user devices 302. Additionally and/or alternatively, the server 301 may provide a web interface that, when accessed by a web browser executing on the one or more spectator devices 303, may allow users to view video corresponding to a two- and/or three-dimensional environment in the multiplayer interactive application.

The one or more databases 304 may store data associated with the multiplayer interactive application. For example, the one or more databases 304 may be a relational database that comprises user account data, such that—e.g., to access the multiplayer interactive application—users of the one or more user devices 302 may be required to provide candidate authentication credentials, and those candidate authentication credentials may be compared to authentication credentials stored in the one or more databases 304. Additionally and/or alternatively, the one or more databases 304 may be configured to store gameplay rules. For example, the one or more databases 304 may be configured to store information defining maximum movement speeds for characters, player health, and the like, such that users of the one or more user devices 302 cannot manipulate operation of their locally-executing multiplayer interactive application to cheat. As will be described in greater detail below, the one or more databases 304 may contain data indicating responses to prompts by one or more users. In this manner, the one or more databases 304 might be usable to build an internal profile corresponding to a user of the multiplayer integrative application. That internal profile, as will be described below, might be usable to automatically select responses to prompts under certain circumstances.

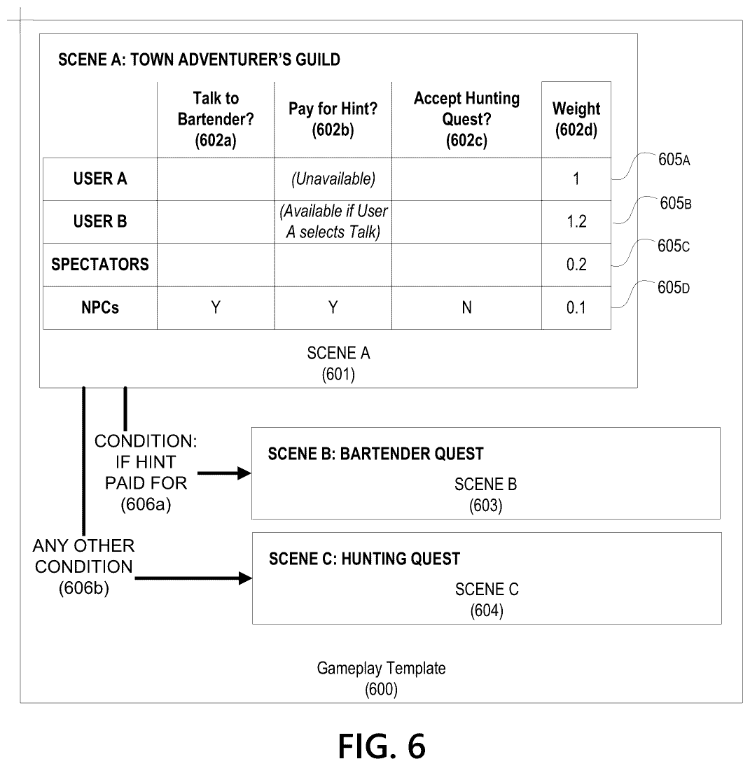

The one or more databases 304 may be configured to store gameplay templates, which may be data that defines one or more scenes for the multiplayer interactive application. As will be described in greater detail below (in, e.g., FIG. 6), such a gameplay template may be a spreadsheet, YAML Ain't Markup Language (yaml) configuration file, collection of data objects, or other data structure that defines how story in a multiplayer interactive application may be displayed. For example, a gameplay template may define how different scenes might be portrayed in the multiplayer interactive application, such as by defining one or more conditions for whether a first scene is followed by a second scene or a third scene. As another example, a gameplay template may define how a scene might be modified for one or more second users based on how one or more first users previously responded to prompts presented during that same scene. As yet another example, a gameplay template may define various weights for different types of possible interactions in the multiplayer interactive application such that, for example, a gameplay template might indicate that some users' choices have a certain weighting over other users' choices, that spectator feedback is weighted a certain way for certain scenes, that non-player characters are biased to certain decisions, or the like.

Providing a Dynamic Asynchronous Choice System (DAX)

Discussion will now turn to various steps which may be performed by computing devices (e.g., the server 301 of FIG. 3, the one or more user devices 302 of FIG. 3, the computing device 201 of FIG. 2, or the like) to provide a dynamic asynchronous choice system (DAX) for multiplayer interactive applications.

FIG. 4 is a flow chart with steps depicting how a scene might be provided to two different users, with one user receiving a modified version of the same scene based on responses to prompts in that scene made by a previous user, and with a subsequent scene selected for both users based on the responses made by both users. The steps depicted in FIG. 4 may be performed by any of the computing devices described above, such as by the server 301 of FIG. 3. A computing device may comprise one or more processors and memory storing instructions that, when executed by the one or more processors, cause the computing device to perform one or more of the steps of FIG. 4. One or more non-transitory computer-readable media may store instructions that, when executed by one or more processors of a computing device, cause the computing device to perform one or more of the steps of FIG. 4.

In step 401, a server may provide a first scene to a first user as part of a multiplayer interactive application. For example, the server may transmit data which is configured to cause a user device associated with the first user to display a first scene. That data might be instructions configured to cause an application executing on a user device (e.g., the multiplayer interactive application) to load and/or display one or more assets associated with the scene. Additionally and/or alternatively, that data might comprise video and/or audio content for the scene, such that the user device might view the data akin to how the user device might display streaming media content.

A scene may comprise any story element (e.g., a story beat, a storylet) of a multiplayer interactive application. For example, a scene might comprise one or more cutscenes that tell a story associated with the multiplayer interactive application. The scene may be in any suitable format. For example, a scene may comprise a series of dialogue between two characters, might comprise an action scene without dialogue, might comprise a relaxing moment of quiet, or the like. Scenes need not be any particular length. For example, one scene might comprise a ten-minute-long video, whereas another scene might comprise two lines of textual dialogue, whereas another scene might be a relaxing moment in a tavern in a virtual world.

In step 402, the server may receive one or more first responses to the first scene from the first user device. The one or more first responses may be responses to one or more prompts provided to the user as part of the first scene. For example, during the first scene, the user might be presented with one or more questions, and the user might, using a user interface, provide one or more responses to these questions. The one or more first responses might comprise actions taken by the user. For example, during the first scene, the user might use user input to cause a user-controllable playable character to interact with a virtual environment, and those interactions may be considered one or more first responses to the first scene. The one or more first responses might be stored in a database, such as the one or more databases 304. In some instances, the one or more first responses may be automatically selected by the server based on a profile, corresponding to a user, stored in the one or more databases 304. For example, if a user does not respond to a prompt within a predetermined period of time, a response might be selected for the prompt and for the user based on a profile, for the user, stored in the one or more databases 304.

Any form of user input, including a lack of user input, may be considered a response to a scene. For example, a user refusing to respond to certain prompts in the multiplayer interactive application might itself be considered a response to those prompts. As another example, a user selection of an option in a user interface may be considered a response. As another example, a user interaction with an object in a user environment (e.g., throwing an in-game ball) may be considered a response.

As part of receiving responses, such as the one or more first responses received in step 402, additional portions of a scene might be provided to a user. For example, as part of step 402, as the server receives one or more first responses to the first scene from the first user device, the server may provide, to the first user device, one or more additional portion(s) of that scene. In this manner, dialogue trees and other conditional events might be implemented within a scene. In some circumstances, this process might be performed by a user device without involvement by the server. For example, the first user device might (e.g., as specified by a gameplay template) modify portions of the first scene based on responses by the first user, then conclude the scene and send (e.g., in the background) the responses to the server as part of step 402. In this manner, a user might be provided the feeling of immediate consequence to their decisions, but those decisions might also be used to affect the gameplay for subsequent users.

In step 403, the server may modify the first scene based on the one or more first responses to the first scene from the first user device. Modifying the first scene may comprise altering the first scene for subsequent users based on responses to the first scene by the first user of the first user device. For example, if a first user decided push a boulder as part of the first scene, then the second user might see, in the first scene, a representation of the first user trying to push the boulder. As another example, if a first user decided to talk to an NPC as part of the first scene, then the second user might see, in the first scene, a representation of the first user talking to the NPC. Along those lines, the first scene might be modified in a variety of ways: modifying the first scene might comprises modifying one or more situations, dialogue, internal monologues, interpretations, camera angles, sounds, music, story twists, story progression, branching, characters, emotions, expressions, choices, mini-game-like interactions, combat outcomes, or the like. That might, in some instances, include a representation of the conversation between the first user and the NPC: for example, they might be able to see, if desired, a user interface showing a chatlog between the first user and the NPC. In some instances, actions by a first user might impact prompts available to subsequent users in the same scene. For example, if the first user responds to a prompt by pushing a boulder in a first scene, a second user might not have the opportunity to push the same boulder, but might instead be presented with the option to push a different boulder. As another example, if the first user decides to talk to an NPC as part of a first scene, a second user might be prevented from talking to the same NPC. The particular nature of which decisions affect others might be established by developers as part of a gameplay template that defines how actions taken by a player (e.g., responses to prompts as stored in a database) might affect scenes (e.g., cause those scenes to be modified) and/or might affect the selection of subsequent scenes, which is discussed further below with respect to FIG. 6.

Modification of the first scene might be conditioned on storage, by a database, of one or more responses corresponding to the first scene. For example, as part of step 403, the server may query a database (such as the one or more databases 304) to determine if one or more responses to the first scene are stored by the database. If such responses are stored, then the first scene might be modified based on those responses. Otherwise, the first scene may be provided in a default state. This may advantageously allow the server to continually modify a scene over time based on more and more responses stored in a database, such that a scene might slowly evolve and change as a virtually unlimited number of users provide responses to that scene.

Modification of the scene may be based on information corresponding to a particular user, such as information about how the user has previously engaged with the multiplayer interactive application. User might interact with the multiplayer interactive application differently, such that a scene might be modified based on how a user has formerly interacted (e.g., interacted in previous scenes) with the multiplayer interactive application so as to reflect past actions by the user. For example, a second user might have previously fought and slain an NPC in the multiplayer interactive application. In such a circumstance, and as part of modifying the first scene for the second user, even though the first scene might normally contain that NPC (e.g., in the background of the scene), the first scene might be modified to remove the NPC such that the second user does not see the NPC. As another example, a second user might have formerly explored a virtual haunted house in the multiplayer interactive application. In such a circumstance, and as part of modifying the first scene for the second user, the first scene might be modified based on the assumption that the second user is familiar with the layout of the virtual haunted house (e.g., to highlight spooky changes to the décor of the house). In this manner, the first scene might be modified not merely based on responses made by previous users to the scene, but also based on individual properties of a user that has not yet experienced the scene. This can advantageously allow each scene to feel evolving (e.g., reflect past decisions made by other players) as well as personal (e.g., to reflect activity made by a particular user). To effectuate this process, data reflecting information corresponding to a particular user (e.g., a log of past actions made by the user in the multiplayer interactive application) might be stored in one or more databases (e.g., the one or more databases 304), and might be retrieved as part of step 403.

In step 404, the server may provide the modified first scene to a second user device as part of the multiplayer interactive application. The method with which the modified first scene is provided to the second user device as part of step 404 may be the same or similar as the method with which the first scene is provided to the first user device as part of step 401. For example, the server may transmit, to the second user device, data which causes a multiplayer interactive application executing on the second user device to display all or portions of the modified first scene.

The process described in step 404 might be referred to as a “Breaking Point,” at which user device(s) that have already provided one or more responses to the first scene and/or modified first scene might be instructed to wait. During that waiting period, other devices might be provided a modified version of the first scene, and those other devices might be provided the opportunity to provide one or more responses to one or more prompts in the modified version of the first scene. For example, while the second user device is provided the modified first scene, the first user device may be instructed to wait (e.g., with a user interface element indicating that one or more other users are making their decisions in a cutscene). That said, such a waiting need not suggest that the user(s) of the first user device must stop enjoying the multiplayer interactive application. For example, as the user(s) of the first user device wait, they may be provided other things to do, such as mini-games, the ability to manage an in-game inventory, the ability to read content, explore a different aspect of the scene, to play other scenes, or the like.

Where possible, the server may endeavor to avoid causing users to wait on one another. To avoid unnecessary delay, the server may provide different users scenes at or around the same time, albeit in a manner where the users are provided prompts at different times. For example, a scene might comprise a two-minute video, a decision opportunity, and then variable length cutscene of anywhere from two to six minutes. In accordance with step 401 through step 403, a first user might be provided the two-minute video, then a decision. Once that decision has been made (that is, once the first user provides a response to a prompt via their first user computing device), then a second user might be provided the two-minute video while the first user is provided a six-minute version of the variable cutscene. Once the second user responds to any applicable prompts after the two-minute video, the second user might be provided the variable cutscene at a length that ensures that the variable length cutscene ends for the second user at or around the same time that it ends for the first user. In this manner, neither user might be required to wait on one another.

In some circumstances (e.g., due to network delay, impatient players, or other foreseen issues), responses from previous users might not be received before step 404 begins. In such circumstances, step 404 may involve generating and providing a modified first scene that is based on information other than previous users' responses. For example, the server may store (e.g., in a database, such as the one or more databases 304) information about historical responses provided by one or more users and may generate a default modified first scene based on those historical responses (e.g., based on predicted responses by users, where those predicted responses are based on actual responses made by those users in the past). In this manner, in circumstances where a modified first scene might not be capable of being generated based on actual responses, the server might create an approximation of a modified first scene based on what it predicts to be likely responses from other users. This process might also be implemented where, for example, one or more previous users do not provide responses. For example, one or more previous users might face technological issues (e.g., game console crashes) that make providing responses within an appropriate time limit difficult. To remedy this problem, the server may determine historical response(s) made by those previous users, predict likely responses by those previous users to the prompts, and then generate and provide the modified first scene based on those predicted likely responses.

In step 405, the server may receive one or more second responses to the first scene from the second user device. The responses received in step 405 may be responsive to one or more second prompts provided as part of the modified first scene. The one or more second prompts provided as part of the modified first scene may be different from the one or more first prompts provided as part of the first scene, and thus the one or more second responses received from the second user device in step 405 may be different than the one or more first responses received from the first user device in step 402. For example, while the one or more first responses might pertain to prompts relating to whether to push a boulder, the one or more second responses might pertain to prompts relating to whether to cut down a tree, how certain users feel about the boulder being pushed, or the like. As another example, while the one or more first responses might pertain to prompts relating to whether to help an NPC, the one or more second responses might indicate an emotional reaction (e.g., one or more emojis) to whether the NPC was helped. As yet another example, while the one or more first responses might relate to lines of dialogue, the one or more second responses might relate to what activity certain players should do next. Those one or more second responses might be stored in a database, such as the one or more databases 304. In some instances, the one or more second responses may be automatically selected by the server based on a profile, corresponding to a second user, stored in the one or more databases 304. For example, if a second user does not respond to a prompt within a predetermined period of time, a response might be selected for the prompt and for the second user based on a second profile, for the second user, stored in the one or more databases 304.

The one or more second responses received in step 405 might correspond to a different kind of response as compared to the one or more first responses received in step 402. For example, a second user of the second user device might make choices that are internal (e.g., relating to the opinions of the second user regarding decisions made by the first user), have long-term effect (e.g., finalizing an in-game decision), or that affect a next phase of a story (e.g., ultimately decide what all users should do, complementing another player). Such prompts and/or responses might not have been available to earlier users. In this manner, the process might permit users to respond and/or react to other users' responses. For example, a user might be prompted to indicate how they feel about a second user, such that the response might be provided to the second user in a subsequent scene.

In step 406, the server may determine a next scene by processing the responses received in step 402 and step 404. As part of this process, server may select a next scene from a plurality of different scenes that follow the first scene based on the responses by various users to the first scene. For example, a gameplay template may define ten different scenes which may follow the first scene and, based on the responses received in step 402 and 404, the server may select from one or more of those ten different scenes. That said, for simplicity purposes, FIG. 4 depicts only two possible subsequent scene options: a second scene and a third scene. But any number of scenes are possible. The determination of the next scene may additionally and/or alternatively be based on votes from users, such that users might select a subsequent scene from a plurality of different scenes both through decisions they made in the past (e.g., in-game interactions) as well as through explicit votes (e.g., voting on a next story beat). For example, the second scene might be selected such that all or portions of the second scene are based on the responses selected by previous users. For instance, if a second user selects a line of dialogue responding to a first user, then that line of dialogue might be presented as part of the second scene. If the processing of the responses received in step 402 and step 404 indicates that the second scene should be selected, the method depicted in FIG. 4 proceeds to step 407. Otherwise, if the processing of the responses received in step 402 and step 404 indicates that the third scene should be selected, the method depicted in FIG. 4 proceeds to step 408.

In some cases, different users might be provided different next scenes based on the processing of the responses received in step 402 and step 404. As one example (not represented in FIG. 4), a first user might be provided a third scene, and a second user might be provided a fourth scene. Such a circumstance might arise where, for example, the users' responses are so different as to effectively take the users on entirely different story paths. For example, the two users might choose to split up, such that their scenes might be entirely different.

As part of step 406, the server may implement a storytelling resolution system. The server may, as part of step 402 and/or step 405, receive a plurality of different responses from a plurality of different users. The server may assign, to one or more of the plurality of different responses, a corresponding story outcome. For example, the server may categorize each of the plurality of different responses into one or more story outcome categories (e.g., “Go Adventuring,” “Stay in Town,” “Stay Friends,” “Get Closer,” “Save Friend” versus “Save Yourself,” etc.). The server may assign weights and/or power ratings to each possible response. Then, the server may compare the different story outcomes to determine which next scene to select. For example, three responses may be received: “Go Hunting,” “Go Exploring,” and “Relax at the Tavern.” The first two of those responses might be categorized as “Go Adventuring,” and the latter of those responses might be categorized as “Stay in Town.” Because more responses indicated that a party should go adventuring, the server may select a scene corresponding to adventuring. With that said, multiplayer interactive application developers might modify this process as desired. For example, the storytelling resolution system may select scenes based on the weight of individual responses (e.g., as weighted based on their importance to the story, the importance of the user(s) providing the response, or the like). As another example, the storytelling resolution system may be configured to portray an outcome (e.g., a scene selection) as a battle between different options. For example, one user may try, via their responses, to cause all players to go adventuring, whereas a next user might argue against such a recommendation (e.g., via their own responses) by indicating that such a decision is too dangerous. In this way, players are not simply voting for discrete options, but rather are able to influence the overall story in subtler (e.g., weighted) ways. This might advantageously surface to users how a particular outcome was achieved. This process might increase the overall dramatic tension of the process. For example, by allowing users to compete for different outcomes, the overall impact of the decision might be given additional weight. This process might be made even more impactful where NPCs are given a “vote” in this process, such that players and NPCs could vie for different outcomes in a story. This veritable decision-making tug-of-war system can add significant interactivity to a game, even where in some instances the multiplayer interactive application might be being enjoyed by some users asynchronously.

In step 407, the server may provide the second scene to both the first user device and the second user device. The second scene may follow the first scene and may continue the story from the first scene based on the responses received in step 402 and step 404. For example, if the responses received in step 402 and step 404 indicate that users decided to talk to a bartender, then the second scene might relate to the discussion with the bartender.

As an example of how the second scene may follow the first scene, assume that the first scene involves two users (a first player and a second player) encountering a virtual impediment, such as an enemy werewolf in an action video game. Each player may, as part of the first scene discussed above, be provided the opportunity to either attack the werewolf, to run, and/or to sacrifice themselves (or the other player) to the werewolf. In such a circumstance, the modified first scene might depict other players' choices (e.g., might depict the first player running away), and the second scene might depict all players' choices (e.g., the first player runs, the second player attacks, and the second scene involves the second player being awarded for their bravery and the first player being lost in the woods).

In step 408, the server may provide the third scene to the first user device and the second user device. The third scene may follow the first scene and may continue the story from the first scene based on the responses received in step 402 and step 404. For example, if the responses received in step 402 and step 404 indicate that users decided to take a hunting quest from an in-game job board, then the third scene might relate to the hunting quest.

The process described above may be modified as desired. For example, the process described above might be looped such that the particular ordering of users is switched. For example, Player A might be provided the first scene as part of step 401, then Player B might be provided the modified first scene as part of step 404. Both players might then be provided the second and/or third scene as part of step 407 and/or step 408. Later, with respect to the same or different scenes, Player B might be provided a fourth scene as part of step 401, and Player A might be provided a modified fourth scene as part of step 404. This sort of looping process might be implemented for fairness, as it ensures that neither player is always the first to make story decisions. Additionally and/or alternatively, as already suggested above, more than two players might be involved in this process. For example, the process depicted in FIG. 4 might be implemented in view of an unlimited plurality of players, such that each player in a sequence affects the scene for subsequent player(s). In this manner, scenes might slowly evolve over time to reflect the decision-making of tens, hundreds, thousands, and/or even millions of previous players.

As an example of how FIG. 4 might operate from the perspective of a server as part of a multiplayer video game, Player A (associated with a first user device) and Player B (associated with a second user device) might be playing the multiplayer video game asynchronously. Player A may initiate a new gameplay story scene, such that the server may receive some indication that Player A wants to initiate the new gameplay story scene. For example, Player A may walk their virtual character into a region of a virtual environment associated with a new part of a story in the game. The server may, as part of step 401, provide a first scene to the first user device. That scene might relate to walking around a fantasy town. The server may then, as part of step 402, receive, from the first user device, one or more first responses to one or more prompts in the first scene. For example, the server might receive an indication that a first user of the first user device wants to talk to an NPC. Those one or more first responses may be stored in a database. This then may cause a breaking point for Player A, wherein they might be instructed to wait until other players make their decision(s). That said, Player A might also be provided other cutscenes, interactive user interfaces, or similar entertainment, such that Player A might not realize that they are in fact waiting on other players. The server may then, based on detecting the one or more first responses stored in the database, generate a modified first scene based on those responses as part of step 403, and provide the modified first scene to the second user device as part of step 404. For example, that modified first scene might show a user-controllable playable character (e.g. an avatar) of Player A talking to an NPC. The server may then, as part of step 405, receive, from the second user device, one or more second responses to one or more second prompts in the modified first scene. Those responses may be to prompts of a different kind: for example, some of the prompts may relate to reacting to decisions already made by Player A. For example, the server might receive an indication that a second user of the second user device wants to join Player A's conversation with the NPC (an option that might not have been available to Player A, as no-one might have been talking to the NPC before). Then, as part of step 406, the server may determine a next scene for Player A and Player B, and might provide it as part of step 407 and/or step 408. This process may loop again, with Player B now provided the first opportunity to provide responses to a subsequent scene.

As an example of how FIG. 4 might operate from the perspective of first user device referenced in step 401, the first user device might receive the opportunity to provide one or more first responses to one or more first prompts for the first scene. That first user device might then be instructed to wait until one or more second users make decisions. During that waiting period, a user of the first user device might be allowed to do other things, such as play a mini-game, access a user interface to manage an in-game inventory, engage with different scenes (with the same or different users), or the like. During that waiting period, the one or more second users using one or more second user devices may be provided the opportunity to provide one or more second responses to one or more second prompts for a modified version of the first scene. At this time, a user of the first user device might be prompted to wait (e.g., with a user interface element instructing the user to wait). Once the one or more second responses are received, a second scene might be provided to all user devices, including the first user device and the one or more second user devices. In some instances, different scenes might be provided to different users. That scene might have been selected based on the responses from all such user devices. Additionally and/or alternatively, this process might be repeated for an unlimited number of users. For example, this process might be repeated across hundreds of different users, such that the response(s) from a large plurality of previous users might affect scene(s) for a large plurality of subsequent users.

As an example of how FIG. 4 might operate from the perspective of one or more second user devices, such as those referenced in step 404, the one or more second user devices might receive the opportunity to provide one or more second responses to a modified version of the first scene. The one or more second user devices need not wait on activity taken by preceding user devices, and might not even know that the first scene has been modified based on responses from other user devices. Once the one or more second responses are received, a second scene might be provided to all user devices, including the one or more second user devices and the first user device. That scene might have been selected based on the responses from all such user devices.

Discussion will now focus on an example of particular steps which might be taken by a server as part of the process described in FIG. 4. FIG. 5 is a flow chart with steps for using a gameplay template to provide asynchronous prompts to users as part of the same scene, then selecting a subsequent scene based on responses from those users. The steps depicted in FIG. 5 may be performed by any of the computing devices described above, such as by the server 301 of FIG. 3. A computing device may comprise one or more processors and memory storing instructions that, when executed by the one or more processors, cause the computing device to perform one or more of the steps of FIG. 5. One or more non-transitory computer-readable media may store instructions that, when executed by one or more processors of a computing device, cause the computing device to perform one or more of the steps of FIG. 5. FIG. 5 depicts steps which may be the same or similar as the steps in FIG. 4, such that, in some cases, both flow charts describe the same overall concept in different but similar ways.

In step 501, a server may provide, to one or more user devices (e.g., the one or more user devices 302), a multiplayer interactive application. As part of this process, the server may provide a server functionality in a client-server relationship between itself and one or more user devices. For instance, the server may transmit instructions to multiplayer interactive applications executing on the one or more user devices that permit users of the one or more user devices to explore virtual worlds, interact with other users, or the like. The particular relationship between the server and the one or more user devices may vary based on the nature of the multiplayer interactive application. For example, for FPS games, the server might manage player character movement, track in-game projectiles, arrange matchmaking, and the like. As another example, for an MMORPG, the server might allow users to create and manage characters, explore virtual worlds, create and manage in-game enemies, and the like. Along those lines, in an interactive narrative experience, choices might be based on what users want to have happen next in a story, or what their characters should do, say, or think. As part of this process, users might be assigned one or more roles. For example, roles may be defined in a gameplay template (such as the gameplay template described below as part of FIG. 6), and users might be assigned one or more of those roles (e.g., by voluntary selection, randomly, based on conditions, and/or some combination thereof). Various aspects of a story (and scenes in that story) might be configured for different roles. For example, certain roles might place users in a “good guy” role in some scenes, whereas other roles might place users in a “bad guy” role in those scenes. Such roles might be specific to scenes in that story. For example, in a circumstance where an NPC flirts with a user, one user might be provided the “flirtee” role, whereas another might be provided a “third wheel” role.

In step 502, the server may determine a gameplay template for the multiplayer interactive application. A gameplay template may be data which defines one or more scenes. The gameplay template may further define one or more responses which might be provided to one or more prompts and by one or more users as part of those scenes and/or interactions. For example, the gameplay template might indicate that, during a scene, users might vote to proceed left or right, and may indicate which scene(s) follow if the users collective choose going left or going right. The gameplay template may further define one or more prompts for spectators of the scene, such that spectators of a scene may provide responses to their own prompts (and, if desired, influence the results of a scene. Spectators might be provided a scene (e.g., before one or more players provide responses, when one or more players provide responses, and/or after one or more players provide responses), and feedback from those spectators might correspond to activity in the scene. For example, the gameplay template might indicate that spectators can also vote whether or not users should go left or right, and those responses might be considered in determining whether the users' user-controllable playable characters (e.g., avatars) go left or right. In this manner, spectators might be able to actively affect the results of gameplay, even in circumstances where the spectators are not watching the gameplay live. The gameplay template may further define NPC responses for a scene, such that the scene might be biased toward a particular result. For example, an NPC in the multiplayer application might indicate (e.g., might be programmed to indicate) that it wants to go left, not right. Such a biased approach might be particularly useful where, for example, there is a possibility of a tie between user responses. In some instances, the environment itself might be considered an NPC, such that (for example) the existence of rain could impact certain decisions. This may advantageously subtly influence the way decisions are made based on factors (e.g., weather, the overall environment) in a scene. The gameplay template may additionally and/or alternatively be configured to indicate weights of different responses from different users, spectators, and NPCs. For example, returning to the go-left-or-right prompt referenced above, users might be given one vote, spectators might be given a fourth of a vote, and NPCs might be given an eighth of a vote. Such a weighting might be based on roles of users. For example, earlier users' responses might be weighted lower than later users' responses, in effect rewarding the latter users for their patience. As another example, users who have more prominent roles in the multiplayer interactive application (e.g., party leaders, new players, players with a premium subscription) might be provided greater weight than other users. As yet another example, some users might have the opportunity to affect the environment of a scene by, for example, causing rain in a scene, which (as noted above) might have a subtle influence on the weighting of certain responses.

In step 503, the server may generate a first series of prompts. The first series of prompts might be based on a scene to be provided to first user(s) of first user device(s). For example, the server may generate, based on a gameplay template that defines a plurality of different scenes based on choices made by users of the multiplayer interactive application, a first series of prompts corresponding to a first scene in the multiplayer interactive application. Each of these series of prompts may comprise opportunities for one or more first users of one or more first user devices to interact in (or, if desired, not interact in) the scene. Such prompts may comprise questions (e.g., as might be provided in a user interface), opportunities to interact with an environment (e.g., movable three-dimensional objects in a three-dimensional environment), or the like. As such, the prompts might be, but need not be, explicit questions to the user.

Generating a series of prompts, such as generating the first series of prompts in step 503, may be based on a history of decisions made by a user. A database may be configured to store a history of past responses to prompts by a user. In turn, a series of prompts might be generated based on the history of past responses to prompts by the user. For example, if a user typically chooses “chaotic good” decisions in a game and/or has chosen a “good” role in the game, then generating the first series of prompts might permit the user to select further chaotic good decisions (or, if desired, respond differently). As another example, if a user typically ignores prompts relating to in-game narratives, then the prompts might permit the user to select more active roles in a story. In this way, the prompts provided to a user might reflect various past decisions made by the user during the multiplayer interactive application.

In step 504, the server may provide the first series of prompts to one or more first user devices as part of a first scene. For example, the server may provide, to a first user computing device of the plurality of different user computing devices executing the multiplayer interactive application and via a network, the first series of prompts. In such an example, the first user computing device may be configured to provide each of the first series of prompts to the first user computing device as part of the first scene. Because the prompts might relate to a wide variety of ways that the user might interact in the multiplayer interactive application, providing the first series of prompts might be provided in a variety of ways. For example, some prompts might be provided via a user interface (e.g., in a dialogue box in a user interface), whereas other prompts might be provided without a user interface (e.g., by allowing a user to interact with an object in a two- and/or three-dimensional environment). This step may be the same or similar as step 401 of FIG. 4.

Scenes, such as the first scene, may be based, in whole or in part, on a history of decisions made by a user. As was described above, a database may be configured to store a history of past responses to prompts by a user. In turn, scenes might be displayed based on the history of decisions made by the user. For example, if a history of past responses by a user indicates that the user has traditionally chosen “bad guy”-type decisions, then the scene might involve NPCs treating the user's player character negatively. As another example, if a history of past responses by a user indicates that the user generally prefers more narrative and less action, then the scene might be modified to include more text and less action scenes. As yet another example, if a user has chosen to kill a particular NPC, then the scene might be modified to not display that particular NPC (by, for example, replacing that particular NPC with a different NPC).

During display of a scene, the scene may be modified based on feedback from one or more users. For instance, based on data indicating that a user is not engaged with (e.g., is bored with) a scene, the scene might be modified to be more exciting. To effectuate this result, engagement data might be collected by monitoring, for example, whether the multiplayer interactive application is an active window in an operating system (e.g., whether the user has alt-tabbed away from a window associated with the multiplayer interactive application), whether the user's eyes are focused on the window (e.g., based on webcam data that captures an image of a face of the user), whether the user is skipping text content in the multiplayer interactive application, or the like.

In step 505, the server may receive a first set of responses to the first series of prompts provided in step 504. For example, the server may receive, from the first user computing device and via the network, a first set of responses corresponding to the first series of prompts. This step may be the same or similar as step 402 of FIG. 4. The responses may comprise user interface selections made by one or more users. For example, the server may cause first user computing device to provide, in a user interface provided by the multiplayer interactive application executing on the first user computing device, one or more selectable options corresponding to the first series of prompts. The responses may be any interaction or lack of interaction by a user in the multiplayer interactive application. For example, one or more of the first set of responses may indicate that a user did not respond to a particular prompt. Though termed as a set of responses in this step (as well as in step 508, below), no particular quantity of responses is required as part of this step. For example, the set may comprise zero responses (e.g., such that a time period associated with responses from a user might time out), which itself might be useful for storytelling purposes (e.g., because zero responses might suggest that the user is no longer engaged with the multiplayer interactive application). In turn, certain responses might be selected by the server based on non-responses by a user. For example, if a user does not provide some sort of response within a predetermined period of time (e.g., one or more minutes, hours, and/or days), the server may select a default and/or automatic response on behalf of the user. Such an automatic response might be based on a history of responses (e.g., to past prompts) by the user. In this manner, other users might not be forced to wait for an undesirably long time before the scene continues. In some cases, steps 504 and 505 may be performed together and/or in a loop. For example, the server may provide a first prompt to the first user computing device, then receive a first response from the first user computing device, then provide a second prompt to the first user computing device, then receive a second response from the first user computing device. As such, the server need not provide all prompts at once, nor does the server need to receive all responses at once.

The responses may be based on virtual actions performed in a virtual environment of the multiplayer interactive application. For example, the server may receive activity data corresponding to one or more virtual actions performed, in the multiplayer interactive application, by a user-controllable playable character (e.g., an in-game avatar) associated with the first user computing device. Such interactions might comprise movement of the user-controllable playable character, actions taken by the user-controllable playable character, interaction with one or more objects in a virtual environment, or the like. The server may then process the activity data to identify the first set of responses. For example, a gameplay template might inquire as to whether a user kicked a box, and the server may process the activity data to determine whether the user caused a user-controllable playable character to kick a box.

In step 506, the server may generate a second series of prompts based on the first set of responses received in step 505. For example, after receiving the first set of responses, the server may generate, based on the first set of responses and based on the gameplay template, a second series of prompts corresponding to the first scene in the multiplayer interactive application. In such an example, the second series of prompts may comprise at least one prompt different from the first series of prompts. This step may be the same or similar as step 403 of FIG. 4.

As part of generating the second series of prompts, the server may modify one or more aspects of the first scene. For example, if one of the first set of responses in step 505 indicates that one or more users of the first user devices decided to move a box from a first location to a second location, then the first scene may be modified such that the box is in the second location. This modification process may be performed to make available, to subsequent users, different choices as compared to the first users of the first user devices. Returning to the example above, the box in the second position might enable subsequent users to climb the box and reach an item, which might not have been possible if the box was in the first position. As a different example, music and/or sound effects in the scene might be modified based on the first set of responses in step 505. For example, based on a first user making relatively bad choices, more dire music might be played during the same scene when presented to a second user.

The second series of prompts may be generated based on input from one or more spectator devices. The server may receive, from one or more spectator computing devices and via the network, feedback data that indicates one or more reactions, by one or more users of the one or more spectator computing devices, to the first scene. The server may then generate the second series of prompts further based on the feedback data. This process might effectuate a level of interactivity for the multiplayer interactive application that enables interaction by spectators (e.g., fans watching on live streamed video). For instance, by allowing the spectators to provide feedback on the responses received in step 505, the scene might reflect whether, for example, spectators feel that the first users of the first user devices responded well to a scene. In this way, spectators (e.g., an audience of the events in the multiplayer interactive application) may affect activity in the application. For example, the spectators may, via their feedback data, decide on how hard a quest will be, what types of animals players need to hunt, how an NPC may respond to player actions, or the like. As another example, the spectators may, via their feedback data, affect an environment in the multiplayer interactive application by, for example, deciding whether there will be rain and/or whether in-game enemies will enter an area.

The feedback data described above may comprise one or more responses to one or more prompts. In this manner, spectators might be able to provide responses to the same or similar prompts as provided to one or more user devices, and thereby influence the story in the multiplayer interactive application. For example, while a first user of a first user device is provided a prompt (e.g., “Talk to Bartender?”), spectators might be able to, using their spectator devices, provide feedback comprising a vote as to whether the first user should respond “Yes” or “No.” Additionally and/or alternatively, spectators might be able to, using their spectator devices, provide feedback comprising a vote as to how various NPCs should act within a scene (e.g., how the aforementioned bartender should respond in a scene). For instance, based on feedback data, a quantity of NPCs in a scene, a weather in a scene, a difficulty of a particular challenge in a scene, or other similar variables of a scene might be modified. As such, spectators might be provided the ability to influence the decisions made by users of the multiplayer interactive application, as well as to influence the conditions of a scene in the multiplayer interactive application. That said, the spectators need not be provided the same prompts as users of the multiplayer interactive application. Spectators may be provided prompts that permit spectators to provide feedback data that alters a story of the multiplayer interactive application in a manner different than how users might alter that story. For example, spectators might be able to cause, using their feedback data, new quests or events to occur in a MMORPG that might not otherwise be available to users of the multiplayer interactive application. The particular timing of the feedback data may vary. For example, spectators might provide feedback data long before users engage with a scene (e.g., such that the feedback data affects various variables of the scene), and/or might be provided during and/or after the scene (e.g., such that the feedback data corresponds to reactions to user choices in a scene).

The feedback data described above may comprise reactions to activity in a scene. Such reactions might comprise, for example, comments, reactions, emoji, text, voice messages, video messages, or the like. In this manner, spectators of a scene might provide their subjective and/or objective evaluations of a scene (e.g., thumbs-up emojis, thumbs-down emojis, heart emoji), and such feedback might be used to influence the trajectory of a scene. For example, based on a quantity of negative reactions satisfying a threshold (e.g., over 50% of spectators providing a thumbs-down emoji), the decisions made by a particular user of the multiplayer interactive application might be weighted (e.g., discounted down, reflecting that spectators did not like those decisions). Such an approach may be useful where spectators are providing feedback on video streaming platforms, such as the TWITCH™ live streaming service by Amazon.com, Inc. of Seattle, WA.

The spectators of the multiplayer interactive application may be provided graphical data (e.g., video) corresponding to the multiplayer interactive application. For example, the server may provide, to the one or more spectator computing devices and via the network, graphical data corresponding to the second scene. That graphical data may comprise one or more frames depicting a two- and/or three-dimensional environment in the multiplayer interactive application. The way in which spectators view the multiplayer interactive application might be based on the way in which they react to decisions made by users. For example, the aforementioned one or more frames may have been captured from a camera perspective, in the two- and/or three-dimensional environment, that is based on the feedback data. This may have various advantages for the spectators. For example, if the feedback data suggests that the spectators prefer one user over another, then the one or more frames might focus on the preferred user. As another example, if the feedback data indicates that the spectators are excited, then more dramatic camera angles might be used. For example, if a user makes choices that excite spectators (as evidenced via the feedback data), then the scene's camera angles might be modified for the spectators (and/or for subsequent users) to be more exciting (e.g., to use more dramatic angles, to move more, or the like).

Spectators might be represented in a scene. For example, as part of the scene, spectators might be represented by various NPCs or other elements within the scene. In this manner, spectators' activity (e.g., feedback data) might be translated into story-appropriate feedback in the scene. For example, if spectators dislike activity of a particular user, then NPCs in a scene in the multiplayer interactive application might audibly boo the user.

The second series of prompts may be generated based on non-player character configurations. As part of the process of deciding which prompts to provide to subsequent users, non-player characters might be programmed with a bias towards one or more story elements. In some instances, that might include a preference regarding the first series of prompts provided to the first user device(s) as part of step 504. For example, the server may determine, based on the gameplay template, a third set of responses corresponding to a non-player character in the multiplayer interactive application. The second series of prompts may be generated based on that third set of responses.

To provide an example of the aforementioned non-player character scenario, the prompts provided as part of step 504 might relate to whether or not two different users want to go left or right. A non-playable character might be configured (e.g., via a gameplay template) to prefer that the users go left. In such a circumstance, if the users each vote differently, then the non-player character's “vote” might be taken into account by the server, and the decision may be to go left.

In step 507, the server may provide the second series of prompts to one or more second user devices as part of the first scene. For example, the server may provide, to a second user computing device executing the multiplayer interactive application and via the network, the second series of prompts. In such an example, the second user computing device may be configured to provide each of the second series of prompts to a second user as part of the first scene. The particular process by which the server provides the second series of prompts to the one or more second user devices may be the same or similar as how the server provided the first series of prompts in step 504. That said, because the prompts might be different, the server might provide the prompts in different ways. For example, the server might provide the first series of prompts in step 504 via a user interface, whereas the server might provide the second series of prompts in step 507 without use of a user interface. This step may be the same or similar as step 404 of FIG. 4.

The server may provide the second series of prompts to the one or more second user devices at a time based on the first set of responses. In this manner, the timing of when the one or more second user devices are provided an opportunity to engage with a scene may depend on the interaction, by one or more previous users, with the same scene. For example, the second series of prompts may be provided after a first user has provided at least one response to a scene. As another example, the second series of prompts may be provided after a first user has provided a predetermined quantity of responses (e.g., three responses) to a predetermined number of prompts (e.g., the first three prompts).

As part of providing this second series of prompts, the server may provide a modified version of the first scene to the one or more second user devices. For example, as described above, the server may modify, based on the first set of responses, display of at least a portion of the first scene such that the first scene indicates at least one choice made by the first user. For example, the first scene might be depicted from a different perspective, might focus on different objects in the scene, might feature objects in different locations, might comprise different dialogue, the camera angles of the scene might change, expressions of NPCs in the scene might change, sounds and/or music in the scene might change, or the like. As another example, as part of providing the first scene to the one or more second user devices, the server may render, in an environment in the multiplayer interactive application, a representation of the first user, wherein the representation of the first user is based on the first set of responses. For example, the representation of the first user might be shown as providing the responses received from the first user. In such an example, second users of the one or more second user devices might be able to observe what decisions that first users of the one or more first user devices made.

As part of providing this second series of prompts, the server may prompt other users to wait. Given the asynchronous nature of the decision-making system described herein, it is possible that some users might be forced to wait on other users' responses for a story to proceed. To address this concept, one or more users might be provided access to a scene while other users might be prompted to wait (e.g., to engage with other content in the multiplayer interactive application other than the scene). In this manner, users that already provided responses in a scene might be caused to wait for other users to provide their responses to a scene. For example, the server may send, to the first user computing device and via the network, a wait command configured to cause display, in the multiplayer interactive application executing on the first user computing device, a notification that a user of the first user computing device should wait on a second user of the second user computing device. That notification might comprise, for instance, a user interface element that informs the user that they should wait on other users to respond to the scene. Once the user(s) in the scene have provided an appropriate quantity of response(s) (and, e.g., have reached a breaking point), then other user(s) might be provided access to the scene, and/or may be provided access to a later scene.

In step 508, the server may receive a second set of responses to the second series of prompts provided in step 507. For example, the server may receive, from the second user computing device and via the network, a second set of responses corresponding to the second series of prompts. The process by which the second set of responses is received in step 508 may be the same or similar as the process by which the first set of responses is received in step 505. That said, because the prompts might be different, the formatting and/or nature of the responses may be different as well. For example, the first set of responses in step 505 might comprise the selection of various user interface elements, whereas the second set of responses in step 508 may comprise movement of a user-controllable playable character. This step may be the same or similar as step 405 of FIG. 4.

In step 509, the server may select a second scene based on the first set of responses received in step 505 and the second set of responses received in step 508. For example, the server may select, from the plurality of different scenes defined by the gameplay template and based on the first set of responses and the second set of responses, a second scene. The process by which this selection is done may be the same or similar as step 406 of FIG. 4.

Selection of the second scene may be based on information in the gameplay template. A gameplay template may specify, using one or more conditions, which types of user responses should result in one scene over another. For example, the server may compare one or more conditions, specified by the gameplay template and corresponding to the second scene, to at least a portion of the first set of responses and the second set of responses. An example of such a gameplay template is discussed below with respect to FIG. 6.

Selection of the second scene may involve weighing input from users, spectators, and/or non-playable characters. For example, the server may weigh the first set of responses based on a first role associated with the first user computing device and may weigh the second set of responses based on a second rule associated with the second user computing device. Then, the server may compare the weighted first set of responses and the weighted second set of responses. In this manner, the different relationships of users, spectators, and/or non-playable characters in a scene might be weighted to account for their importance to the story. For instance, users might be generally provided more weight in deciding the next steps of a scene over spectators and/or non-playable characters. As another example, users' responses might be weighted based on when they provided a response (e.g., such that later users' responses might be given greater weight than earlier users' responses, effectively rewarding them for waiting for their turn to provide responses).

In step 510, the server may provide the second scene selected in step 509 to the first user device and the second user device. For example, the server may provide, to the first user computing device and the second user computing device and via the network, data corresponding to the second scene. In such an example, the first user computing device and the second user computing device may be configured to provide, in the multiplayer interactive application, the second scene.

The second scene may indicate one or more portions of the responses made by users to a previous scene. In this manner, the second scene might reflect previous responses made by one or more users. For example, the server may modify, based on the first set of responses, display of at least a portion of the second scene such that the first scene indicates at least one choice made by the first user and at least one second choice made by the second user.

Though both FIG. 4 and FIG. 5 describe actions taken by a server, in some circumstances, a server (e.g., the server 301) might be omitted. For example, some developers might develop peer-to-peer multiplayer interactive applications which execute collectively amongst various user devices (e.g., the user devices 302). In such a peer-to-peer circumstances, any or all of the steps described above with respect to FIG. 4 and/or FIG. 5 may be performed by one or more user devices, rather than the server.

FIG. 6 depicts an example of a gameplay template 600 that shows how choices made by users, spectators, and NPCs might affect the choice of subsequent scenes based on one or more conditions for those subsequent scenes. The gameplay template 600 depicted in FIG. 6 includes three scenes: scene A 601, scene B 603, and scene C 604. Scene A 601 includes details about various prompts which might be provided to users and spectators during the scene. This information is depicted by a table. Column 602a corresponds to a prompt to talk to a bartender, column 602b corresponds to a prompt to pay for a hint, column 602c corresponds to a prompt to accept a hunting quest, and column 602d indicates a weighting value for a particular class of user, spectator, and/or NPC. Row 605a of that table corresponds to responses from a first user (User A), row 605b of that table corresponds to responses from a second user (User B), row 605c of that table corresponds to responses from spectators, and row 605d of that table corresponds to preprogrammed responses from NPCs.

The latter of the two scenes (scene B 603 and scene C 604) follow scene A 601, and are associated with scene A 601 by one or more conditions. If the first conditions 606a (“if hint paid for”) are satisfied, scene B 603 follows scene A 601. That said, if the second conditions 606b (“any other condition”) are satisfied (that is, if the first conditions 606a are not met), scene C 604 follows scene A 601. As such, the gameplay template 600 illustrates how different conditions (e.g., the first conditions 606a and the second conditions 606b) might inform a server whether to go from a first scene to a second scene or a third scene.

The gameplay template 600 indicates that a gameplay template may indicate how prompts are different for different users. For example, User A is not provided the opportunity to pay for a hint, whereas User B is provided that decision only if User A decided to talk to bartender. In this manner, the gameplay template 600 indicates how a scene might be modified (e.g., to allow User B to talk to a bartender) in a manner such that users have different experiences for the same scene and in a manner where different users may have the opportunity to respond to different prompts.

The gameplay template 600 also illustrates how different types of users might be provided different weights. For example, as indicated above, different users' responses might be provided different weights based on their roles in the multiplayer interactive application, the ordering in which they provided a response to the scene, or the like. The column 602d indicates different weights for each of User A, User B, spectators, and NPCs. This indicates that each of these different users might be provided a different level of ability to influence the story in a particular scene. This might also make the overall process fairer. For example, subsequent users might be provided a greater weight than previous users (to account for the fact that they didn't get to respond to the scene early on, and to reward them for waiting), whereas spectators might not be provided much weight at all (to ensure that viewers cannot force users into stories they are not interested in engaging with).

The gameplay template 600 also indicates how a gameplay template might specify when certain users wait on other users' activity. For example, the gameplay template 600 indicates that User A goes first, and is provided two different options. Then, after User A makes such decisions (that is, a point which might be referred to as a break point), User B may be provided the opportunity to make decisions. In this manner, the gameplay template 600 may indicate that, after User A provides responses, User A might wait until User B (and/or the spectators) provide responses. In some instances, the gameplay template 600 may additionally or alternatively define a time period for a user response timeout. For example, the gameplay template 600 may indicate that, if User A does not provide a response within thirty seconds, then a default option (e.g., “Talk to Bartender”) might be selected. In this manner, gameplay might be modified such that, in some circumstances, users might be required to respond to prompts quickly (e.g., to facilitate a high-energy, potentially stressful atmosphere for certain decisions).

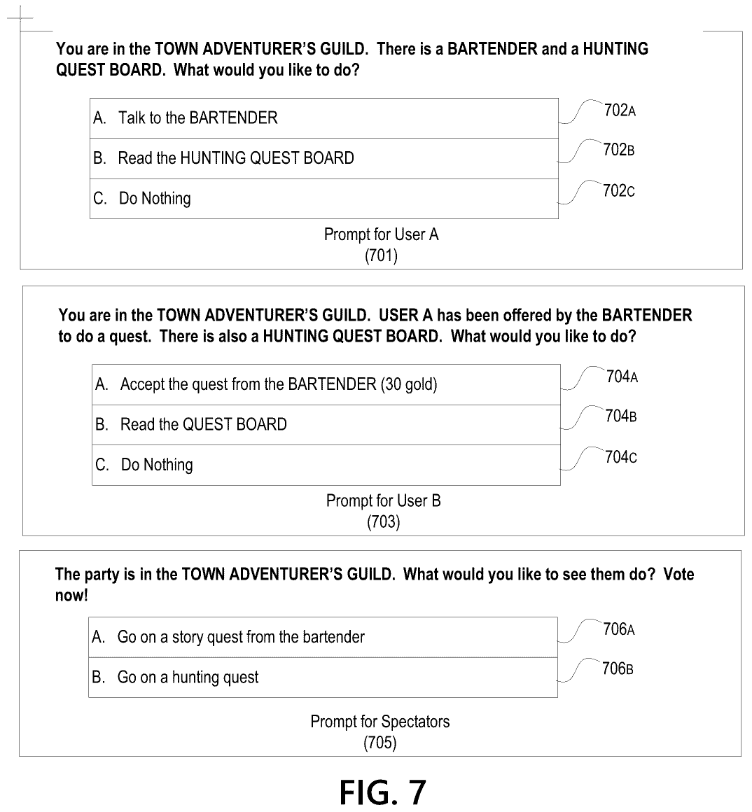

FIG. 7 shows examples of different prompts for different users and spectators. More particularly, the prompts depicted in FIG. 7 illustrate the kind of prompts that might be generated based on the gameplay template 600 of FIG. 6. A first prompt for user A 701 may provide a first option 702a (relating to talking to a bartender), a second option 702b (relating to reading a hunting quest board), and a third option 702c (doing nothing) for a first user. A second prompt for user B 703 may provide a first option 704a (relating to accepting a quest from the bartender, suggesting that User A selected the first option 702a), a second option 704b (relating to reading a hunting quest board), and a third option 704c (doing nothing) for a second user. As part of the first option 704a, a representation of user A may be shown talking to the bartender if the user selected the first option 702a, thereby indicating to the user B that user A selected the first option 702a. A spectator prompt 705 may provide a first option 706a (encouraging the users to go on a story quest form the bartender, corresponding to both the first option 702a and the first option 704a) and a second option 706b (relating to a hunting quest, corresponding to the second option 702b and the second option 704b) for spectators.

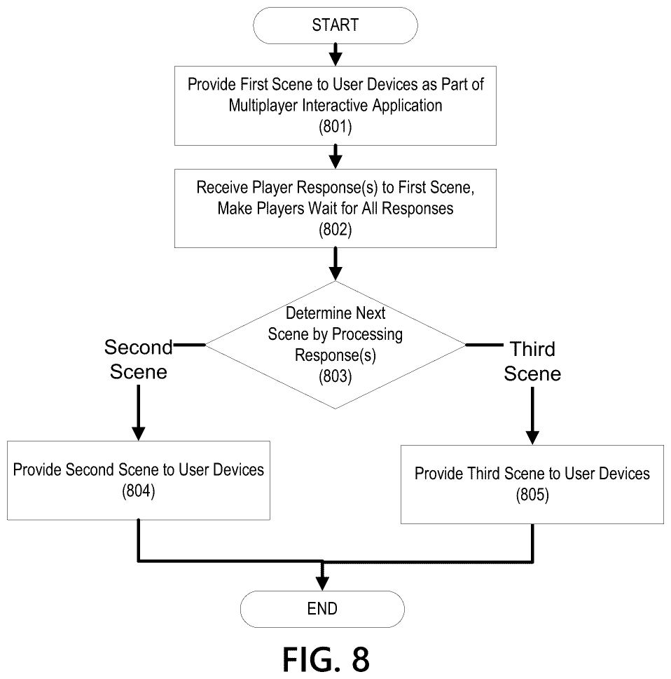

Discussion will now briefly touch on a synchronous storytelling functionality. Before, during, or after the asynchronous process depicted in FIG. 4 or FIG. 5, the server might provide users the opportunity to provide responses to the same scene, without modification of that scene. In other words, all users might be provided a vote, and might be required to wait on one another. This process is different than the process described in FIG. 4 and/or FIG. 5, and is provided because it might be provided in conjunction with the process described in FIG. 4 and/or FIG. 5. For example, while some scenes might be provided in accordance with the process described in FIG. 4 and/or FIG. 5, other scenes might be provided in accordance with the process described in FIG. 8.

FIG. 8 is a flow chart with steps for using a gameplay template to provide a synchronous prompt to users as part of the same scene, then selecting a subsequent scene based on responses from those users. The steps depicted in FIG. 8 may be performed by any of the computing devices described above, such as by the server 301 of FIG. 3. A computing device may comprise one or more processors and memory storing instructions that, when executed by the one or more processors, cause the computing device to perform one or more of the steps of FIG. 8. One or more non-transitory computer-readable media may store instructions that, when executed by one or more processors of a computing device, cause the computing device to perform one or more of the steps of FIG. 8. FIG. 8 depicts steps which may be the same or similar as the steps in FIG. 4 or FIG. 5, such that, in some cases, both flow charts describe the same overall concept in different but similar ways.

In step 801, the server may provide a first scene to a plurality of user devices as part of a multiplayer interactive application. This process may be the same as step 401 of FIG. 4 and/or step 504 of FIG. 5. For example, the server may transmit data to the plurality of user devices that causes those user devices to output the first scene.

In step 802, the server may receive one or more responses to one or more prompts provided as part of the first scene. This step may be the same or similar as step 402 of FIG. 4 and/or step 505 of FIG. 5; however, during this process, all users might be required to wait until all or substantially all users have provided a response. In other words, the scene may remain the same for all or substantially all users, and thus the users might all be provided the opportunity to respond to a prompt. The users might only be provided a certain amount of time to respond to the one or more prompts. For example, the users might be provided up to ten minutes to respond to the one or more prompts.

In step 803, the server may determine a next scene based on the responses received in step 802. This step may be the same or similar as step 406 of FIG. 4 or step 509 of FIG. 5. The server may decide, based on the responses, to proceed to a second scene, in which the flow chart depicted in FIG. 8 may proceed to step 804. In step 804, the server may provide a second scene to the plurality of user devices. Alternatively, the server may decide, based on the responses, to proceed to a third scene, in which the flow chart depicted in FIG. 8 may proceed to step 805. Alternatively, in step 805, the server may provide a third scene to the plurality of user devices.

The following paragraphs (M1) through (M12) describe examples of methods that may be implemented in accordance with the present disclosure.

(M1) A method for providing, by a server, a dynamic asynchronous choice system (DAX) for a plurality of different user computing devices executing a multiplayer interactive application, the method comprising: generating, based on a gameplay template that defines a plurality of different scenes based on choices made by users of the multiplayer interactive application, a first series of prompts corresponding to a first scene in the multiplayer interactive application; providing, to a first user computing device of the plurality of different user computing devices executing the multiplayer interactive application and via a network, the first series of prompts, wherein the first user computing device is configured to provide each of the first series of prompts to the first user computing device as part of the first scene; receiving, from the first user computing device and via the network, a first set of responses corresponding to the first series of prompts; after receiving the first set of responses: generating, based on the first set of responses and based on the gameplay template, a second series of prompts corresponding to the first scene in the multiplayer interactive application; providing, to a second user computing device executing the multiplayer interactive application and via the network, the second series of prompts, wherein the second user computing device is configured to provide each of the second series of prompts to a second user as part of the first scene; and receiving, from the second user computing device and via the network, a second set of responses corresponding to the second series of prompts; selecting, from the plurality of different scenes defined by the gameplay template and based on the first set of responses and the second set of responses, a second scene; and providing, to the first user computing device and the second user computing device and via the network, data corresponding to the second scene, wherein the first user computing device and the second user computing device are configured to provide, in the multiplayer interactive application, the second scene.

(M2) The method described in paragraph (M1), further comprising: receiving, from one or more spectator computing devices and via the network, feedback data that indicates one or more reactions, by one or more users of the one or more spectator computing devices, to the first scene, wherein generating the second series of prompts is further based on the feedback data.

(M3) The method described in paragraph (M2), further comprising: providing, to the one or more spectator computing devices and via the network, graphical data corresponding to the second scene, wherein the graphical data comprises one or more frames depicting an environment in the multiplayer interactive application, and wherein the one or more frames are captured from a camera perspective, in the environment, that is based on the feedback data.

(M4) The method described in any one of paragraphs (M1)-(M3), further comprising: determining, based on the gameplay template, a third set of responses corresponding to a non-player character in the multiplayer interactive application, wherein generating the second series of prompts is further based on the third set of responses.

(M5) The method described in any one of paragraphs (M1)-(M4), wherein providing, to the second user computing device executing the multiplayer interactive application, the second series of prompts comprises: sending, to the first user computing device and via the network, a wait command configured to cause display, in the multiplayer interactive application executing on the first user computing device, a notification that a user of the first user computing device should wait on a second user of the second user computing device.

(M6) The method described in any one of paragraphs (M1)-(M5), wherein providing, to the second user computing device executing the multiplayer interactive application, the second series of prompts comprises: modifying, based on the first set of responses, display of at least a portion of the first scene such that the first scene indicates at least one choice made by the first user.

(M7) The method described in any one of paragraphs (M1)-(M6), wherein providing, to the first user computing device and the second user computing device, data corresponding to the second scene comprises: modifying, based on the first set of responses, display of at least a portion of the second scene such that the first scene indicates at least one choice made by the first user and at least one second choice made by the second user.

(M8) The method described in any one of paragraphs (M1)-(M7), wherein providing, to the second user computing device executing the multiplayer interactive application, the second series of prompts comprises: rendering, in an environment in the multiplayer interactive application, a representation of the first user, wherein the representation of the first user is based on the first set of responses.

(M9) The method described in any one of paragraphs (M1)-(M8), wherein selecting the second scene comprises: comparing one or more conditions, specified by the gameplay template and corresponding to the second scene, to at least a portion of the first set of responses and the second set of responses.

(M10) The method described in any one of paragraphs (M1)-(M9), wherein receiving the first set of responses corresponding to the first series of prompts comprises: receiving activity data corresponding to one or more virtual actions performed, in the multiplayer interactive application, by a user-controllable playable character associated with the first user computing device; and process the activity data to identify the first set of responses.

(M11) The method described in any one of paragraphs (M1)-(M10), wherein selecting the second scene comprises weighting the first set of responses based on a first role associated with the first user computing device; weighting the second set of responses based on a second rule associated with the second user computing device; and comparing the weighted first set of responses and the weighted second set of responses.

(M12) The method described in any one of paragraphs (M1)-(M11), wherein providing the first series of prompts comprises causing the first user computing device to provide, in a user interface provided by the multiplayer interactive application executing on the first user computing device, one or more selectable options corresponding to the first series of prompts.

The following paragraphs (A1) through (A12) describe examples of apparatuses that may be implemented in accordance with the present disclosure.

(A1) A server configured to provide a dynamic asynchronous choice system (DAX) for a plurality of different user computing devices executing a multiplayer interactive application, the server comprising: one or more processors; and memory storing instructions that, when executed by the one or more processors, cause the server to: generate, based on a gameplay template that defines a plurality of different scenes based on choices made by users of the multiplayer interactive application, a first series of prompts corresponding to a first scene in the multiplayer interactive application; provide, to a first user computing device of the plurality of different user computing devices executing the multiplayer interactive application and via a network, the first series of prompts, wherein the first user computing device is configured to provide each of the first series of prompts to the first user computing device as part of the first scene; receive, from the first user computing device and via the network, a first set of responses corresponding to the first series of prompts; after receiving the first set of responses: generate, based on the first set of responses and based on the gameplay template, a second series of prompts corresponding to the first scene in the multiplayer interactive application; provide, to a second user computing device executing the multiplayer interactive application and via the network, the second series of prompts, wherein the second user computing device is configured to provide each of the second series of prompts to a second user as part of the first scene; and receive, from the second user computing device and via the network, a second set of responses corresponding to the second series of prompts; select, from the plurality of different scenes defined by the gameplay template and based on the first set of responses and the second set of responses, a second scene; and provide, to the first user computing device and the second user computing device and via the network, data corresponding to the second scene, wherein the first user computing device and the second user computing device are configured to provide, in the multiplayer interactive application, the second scene.

(A2) The server described in paragraph (A1), wherein the instructions, when executed by the one or more processors, further cause the server to: receive, from one or more spectator computing devices and via the network, feedback data that indicates one or more reactions, by one or more users of the one or more spectator computing devices, to the first scene, wherein the instructions, when executed by the one or more processors, cause the server to generate the second series of prompts further based on the feedback data.

(A3) The server described in paragraph (A2), wherein the instructions, when executed by the one or more processors, further cause the server to: provide, to the one or more spectator computing devices and via the network, graphical data corresponding to the second scene, wherein the graphical data comprises one or more frames depicting an environment in the multiplayer interactive application, and wherein the one or more frames are captured from a camera perspective, in the environment, that is based on the feedback data.

(A4) The server described in any one of paragraphs (A1)-(A3), wherein the instructions, when executed by the one or more processors, further cause the server to: determine, based on the gameplay template, a third set of responses corresponding to a non-player character in the multiplayer interactive application, wherein the instructions, when executed by the one or more processors, cause the server to generate the second series of prompts further based on the third set of responses.

(A5) The server described in any one of paragraphs (A1)-(A4), wherein the instructions, when executed by the one or more processors, cause the server to provide, to the second user computing device executing the multiplayer interactive application, the second series of prompts by causing the server to: send, to the first user computing device and via the network, a wait command configured to cause display, in the multiplayer interactive application executing on the first user computing device, a notification that a user of the first user computing device should wait on a second user of the second user computing device.

(A6) The server described in any one of paragraphs (A1)-(A5), wherein the instructions, when executed by the one or more processors, cause the server to provide, to the second user computing device executing the multiplayer interactive application, the second series of prompts by causing the server to: modify, based on the first set of responses, display of at least a portion of the first scene such that the first scene indicates at least one choice made by the first user.

(A7) The server described in any one of paragraphs (A1)-(A6), wherein the instructions, when executed by the one or more processors, cause the server to provide, to the first user computing device and the second user computing device, data corresponding to the second scene by causing the server to: modify, based on the first set of responses, display of at least a portion of the second scene such that the first scene indicates at least one choice made by the first user and at least one second choice made by the second user.

(A8) The server described in any one of paragraphs (A1)-(A7), wherein the instructions, when executed by the one or more processors, cause the server to provide, to the second user computing device executing the multiplayer interactive application, the second series of prompts by causing the server to render, in an environment in the multiplayer interactive application, a representation of the first user, wherein the representation of the first user is based on the first set of responses.

(A9) The server described in any one of paragraphs (A1)-(A8), wherein the instructions, when executed by the one or more processors, cause the server to select the second scene by causing the server to: compare one or more conditions, specified by the gameplay template and corresponding to the second scene, to at least a portion of the first set of responses and the second set of responses.

(A10) The server described in any one of paragraphs (A1)-(A9), wherein the instructions, when executed by the one or more processors, cause the server to receive the first set of responses corresponding to the first series of prompts by causing the server to: receive activity data corresponding to one or more virtual actions performed, in the multiplayer interactive application, by a user-controllable playable character associated with the first user computing device; and process the activity data to identify the first set of responses.

(A11) The server described in any one of paragraphs (A1)-(A10), wherein the instructions, when executed by the one or more processors, cause the server to select the second scene by causing the server to: weigh the first set of responses based on a first role associated with the first user computing device; weigh the second set of responses based on a second rule associated with the second user computing device; and compare the weighted first set of responses and the weighted second set of responses.

(A12) The server described in any one of paragraphs (A1)-(A11), wherein the instructions, when executed by the one or more processors, cause the server to provide the first series of prompts by causing the server to: cause first user computing device to provide, in a user interface provided by the multiplayer interactive application executing on the first user computing device, one or more selectable options corresponding to the first series of prompts.

The following paragraphs (CRM1) through (CRM12) describe examples of computer-readable media that may be implemented in accordance with the present disclosure.

(CRM1) One or more non-transitory computer-readable media storing instructions that, when executed by one or more processors of a server, are configured to cause the server to provide a dynamic asynchronous choice system (DAX) for a plurality of different user computing devices executing a multiplayer interactive application by causing the server to: generate, based on a gameplay template that defines a plurality of different scenes based on choices made by users of the multiplayer interactive application, a first series of prompts corresponding to a first scene in the multiplayer interactive application; provide, to a first user computing device of the plurality of different user computing devices executing the multiplayer interactive application and via a network, the first series of prompts, wherein the first user computing device is configured to provide each of the first series of prompts to the first user computing device as part of the first scene; receive, from the first user computing device and via the network, a first set of responses corresponding to the first series of prompts; after receiving the first set of responses: generate, based on the first set of responses and based on the gameplay template, a second series of prompts corresponding to the first scene in the multiplayer interactive application; provide, to a second user computing device executing the multiplayer interactive application and via the network, the second series of prompts, wherein the second user computing device is configured to provide each of the second series of prompts to a second user as part of the first scene; and receive, from the second user computing device and via the network, a second set of responses corresponding to the second series of prompts; select, from the plurality of different scenes defined by the gameplay template and based on the first set of responses and the second set of responses, a second scene; and provide, to the first user computing device and the second user computing device and via the network, data corresponding to the second scene, wherein the first user computing device and the second user computing device are configured to provide, in the multiplayer interactive application, the second scene.

(CRM2) The one or more non-transitory computer-readable media described in paragraph (CRM1), wherein the instructions, when executed by the one or more processors, further cause the server to: receive, from one or more spectator computing devices and via the network, feedback data that indicates one or more reactions, by one or more users of the one or more spectator computing devices, to the first scene, wherein the instructions, when executed by the one or more processors, cause the server to generate the second series of prompts further based on the feedback data.

(CRM3) The one or more non-transitory computer-readable media described in paragraph (CRM2), wherein the instructions, when executed by the one or more processors, further cause the server to: provide, to the one or more spectator computing devices and via the network, graphical data corresponding to the second scene, wherein the graphical data comprises one or more frames depicting an environment in the multiplayer interactive application, and wherein the one or more frames are captured from a camera perspective, in the environment, that is based on the feedback data.

(CRM4) The one or more non-transitory computer-readable media described in any one of paragraphs (CRM1)-(CRM3), wherein the instructions, when executed by the one or more processors, further cause the server to: determine, based on the gameplay template, a third set of responses corresponding to a non-player character in the multiplayer interactive application, wherein the instructions, when executed by the one or more processors, cause the server to generate the second series of prompts further based on the third set of responses.

(CRM5) The one or more non-transitory computer-readable media described in any one of paragraphs (CRM1)-(CRM4), wherein the instructions, when executed by the one or more processors, cause the server to provide, to the second user computing device executing the multiplayer interactive application, the second series of prompts by causing the server to: send, to the first user computing device and via the network, a wait command configured to cause display, in the multiplayer interactive application executing on the first user computing device, a notification that a user of the first user computing device should wait on a second user of the second user computing device.

(CRM6) The one or more non-transitory computer-readable media described in any one of paragraphs (CRM1)-(CRM5), wherein the instructions, when executed by the one or more processors, cause the server to provide, to the second user computing device executing the multiplayer interactive application, the second series of prompts by causing the server to: modify, based on the first set of responses, display of at least a portion of the first scene such that the first scene indicates at least one choice made by the first user.

(CRM7) The one or more non-transitory computer-readable media described in any one of paragraphs (CRM1)-(CRM6), wherein the instructions, when executed by the one or more processors, cause the server to provide, to the first user computing device and the second user computing device, data corresponding to the second scene by causing the server to: modify, based on the first set of responses, display of at least a portion of the second scene such that the first scene indicates at least one choice made by the first user and at least one second choice made by the second user.

(CRM8) The one or more non-transitory computer-readable media described in any one of paragraphs (CRM1)-(CRM7), wherein the instructions, when executed by the one or more processors, cause the server to provide, to the second user computing device executing the multiplayer interactive application, the second series of prompts by causing the server to render, in an environment in the multiplayer interactive application, a representation of the first user, wherein the representation of the first user is based on the first set of responses.

(CRM9) The one or more non-transitory computer-readable media described in any one of paragraphs (CRM1)-(CRM8), wherein the instructions, when executed by the one or more processors, cause the server to select the second scene by causing the server to: compare one or more conditions, specified by the gameplay template and corresponding to the second scene, to at least a portion of the first set of responses and the second set of responses.

(CRM10) The one or more non-transitory computer-readable media described in any one of paragraphs (CRM1)-(CRM9), wherein the instructions, when executed by the one or more processors, cause the server to receive the first set of responses corresponding to the first series of prompts by causing the server to: receive activity data corresponding to one or more virtual actions performed, in the multiplayer interactive application, by a user-controllable playable character associated with the first user computing device; and process the activity data to identify the first set of responses.

(CRM11) The one or more non-transitory computer-readable media described in any one of paragraphs (CRM1)-(CRM10), wherein the instructions, when executed by the one or more processors, cause the server to select the second scene by causing the server to: weigh the first set of responses based on a first role associated with the first user computing device; weigh the second set of responses based on a second rule associated with the second user computing device; and compare the weighted first set of responses and the weighted second set of responses.

(CRM12) The one or more non-transitory computer-readable media described in any one of paragraphs (CRM1)-(CRM11), wherein the instructions, when executed by the one or more processors, cause the server to provide the first series of prompts by causing the server to: cause first user computing device to provide, in a user interface provided by the multiplayer interactive application executing on the first user computing device, one or more selectable options corresponding to the first series of prompts.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A server configured to provide a dynamic asynchronous choice system (DAX) for a plurality of different user computing devices executing a multiplayer interactive application, the server comprising:
one or more processors; and
memory storing instructions that, when executed by the one or more processors, cause the server to:
generate, based on a gameplay template that defines a plurality of different scenes based on choices made by users of the multiplayer interactive application, a first series of prompts corresponding to a first scene in the multiplayer interactive application;
provide, to a first user computing device of the plurality of different user computing devices executing the multiplayer interactive application and via a network, the first series of prompts, wherein the first user computing device is configured to provide each of the first series of prompts to the first user computing device as part of the first scene;
receive, from the first user computing device and via the network, a first set of responses corresponding to the first series of prompts;
after receiving the first set of responses:
generate, based on the first set of responses and based on the gameplay template, a second series of prompts corresponding to the first scene in the multiplayer interactive application;
provide, to a second user computing device executing the multiplayer interactive application and via the network, the second series of prompts, wherein the second user computing device is configured to provide each of the second series of prompts to a second user as part of the first scene; and
receive, from the second user computing device and via the network, a second set of responses corresponding to the second series of prompts;
select, from the plurality of different scenes defined by the gameplay template and based on the first set of responses and the second set of responses, a second scene; and
provide, to the first user computing device and the second user computing device and via the network, data corresponding to the second scene, wherein the first user computing device and the second user computing device are configured to provide, in the multiplayer interactive application, the second scene.

2. The server of claim 1, wherein the instructions, when executed by the one or more processors, further cause the server to:
receive, from one or more spectator computing devices and via the network, feedback data that indicates one or more reactions, by one or more users of the one or more spectator computing devices, to the first scene, wherein the instructions, when executed by the one or more processors, cause the server to generate the second series of prompts further based on the feedback data.

3. The server of claim 2, wherein the instructions, when executed by the one or more processors, further cause the server to:
provide, to the one or more spectator computing devices and via the network, graphical data corresponding to the second scene, wherein the graphical data comprises one or more frames depicting an environment in the multiplayer interactive application, and wherein the one or more frames are captured from a camera perspective, in the environment, that is based on the feedback data.

4. The server of claim 1, wherein the instructions, when executed by the one or more processors, further cause the server to:
determine, based on the gameplay template, a third set of responses corresponding to a non-player character in the multiplayer interactive application, wherein the instructions, when executed by the one or more processors, cause the server to generate the second series of prompts further based on the third set of responses.

5. The server of claim 1, wherein the instructions, when executed by the one or more processors, cause the server to provide, to the second user computing device executing the multiplayer interactive application, the second series of prompts by causing the server to:
send, to the first user computing device and via the network, a wait command configured to cause display, in the multiplayer interactive application executing on the first user computing device, a notification that a user of the first user computing device should wait on a second user of the second user computing device.

6. The server of claim 1, wherein the instructions, when executed by the one or more processors, cause the server to provide, to the second user computing device executing the multiplayer interactive application, the second series of prompts by causing the server to:
modify, based on the first set of responses, display of at least a portion of the first scene such that the first scene indicates at least one choice made by the first user.

7. The server of claim 1, wherein the instructions, when executed by the one or more processors, cause the server to provide, to the first user computing device and the second user computing device, data corresponding to the second scene by causing the server to:
modify, based on the first set of responses, display of at least a portion of the second scene such that the first scene indicates at least one choice made by the first user and at least one second choice made by the second user.

8. The server of claim 1, wherein the instructions, when executed by the one or more processors, cause the server to provide, to the second user computing device executing the multiplayer interactive application, the second series of prompts by causing the server to render, in an environment in the multiplayer interactive application, a representation of the first user, wherein the representation of the first user is based on the first set of responses.

9. The server of claim 1, wherein the instructions, when executed by the one or more processors, cause the server to select the second scene by causing the server to:
compare one or more conditions, specified by the gameplay template and corresponding to the second scene, to at least a portion of the first set of responses and the second set of responses.

10. The server of claim 1, wherein the instructions, when executed by the one or more processors, cause the server to receive the first set of responses corresponding to the first series of prompts by causing the server to:
receive activity data corresponding to one or more virtual actions performed, in the multiplayer interactive application, by a user-controllable playable character associated with the first user computing device; and
process the activity data to identify the first set of responses.

11. The server of claim 1, wherein the instructions, when executed by the one or more processors, cause the server to select the second scene by causing the server to:
weigh the first set of responses based on a first role associated with the first user computing device;
weigh the second set of responses based on a second rule associated with the second user computing device; and
compare the weighted first set of responses and the weighted second set of responses.

12. The server of claim 1, wherein the instructions, when executed by the one or more processors, cause the server to provide the first series of prompts by causing the server to:
cause the first user computing device to provide, in a user interface provided by the multiplayer interactive application executing on the first user computing device, one or more selectable options corresponding to the first series of prompts.

13. One or more non-transitory computer-readable media storing instructions that, when executed by one or more processors of a server configured to provide a dynamic asynchronous choice system (DAX) for a plurality of different user computing devices executing a multiplayer interactive application, cause the server to:
generate, based on a gameplay template that defines a plurality of different scenes based on choices made by users of the multiplayer interactive application, a first series of prompts corresponding to a first scene in the multiplayer interactive application;
provide, to a first user computing device of the plurality of different user computing devices executing the multiplayer interactive application and via a network, the first series of prompts, wherein the first user computing device is configured to provide each of the first series of prompts to the first user computing device as part of the first scene;
receive, from the first user computing device and via the network, a first set of responses corresponding to the first series of prompts;
after receiving the first set of responses:
generate, based on the first set of responses and based on the gameplay template, a second series of prompts corresponding to the first scene in the multiplayer interactive application;
provide, to a second user computing device executing the multiplayer interactive application and via the network, the second series of prompts, wherein the second user computing device is configured to provide each of the second series of prompts to a second user as part of the first scene; and
receive, from the second user computing device and via the network, a second set of responses corresponding to the second series of prompts;
select, from the plurality of different scenes defined by the gameplay template and based on the first set of responses and the second set of responses, a second scene; and
provide, to the first user computing device and the second user computing device and via the network, data corresponding to the second scene, wherein the first user computing device and the second user computing device are configured to provide, in the multiplayer interactive application, the second scene.

14. The one or more non-transitory computer-readable media of claim 13, wherein the instructions, when executed by the one or more processors, further cause the server to:
receive, from one or more spectator computing devices and via the network, feedback data that indicates one or more reactions, by one or more users of the one or more spectator computing devices, to the first scene, wherein the instructions, when executed by the one or more processors, cause the server to generate the second series of prompts further based on the feedback data.

15. The one or more non-transitory computer-readable media of claim 13, wherein the instructions, when executed by the one or more processors, further cause the server to:
determine, based on the gameplay template, a third set of responses corresponding to a non-player character in the multiplayer interactive application, wherein the instructions, when executed by the one or more processors, cause the server to generate the second series of prompts further based on the third set of responses.

16. The one or more non-transitory computer-readable media of claim 13, wherein the instructions, when executed by the one or more processors, further cause the server to provide, to the second user computing device executing the multiplayer interactive application, the second series of prompts by causing the server to:
send, to the first user computing device and via the network, a wait command configured to cause display, in the multiplayer interactive application executing on the first user computing device, a notification that a user of the first user computing device should wait on a second user of the second user computing device.

17. A method for providing, by a server, a dynamic asynchronous choice system (DAX) for a plurality of different user computing devices executing a multiplayer interactive application, the method comprising:
generating, based on a gameplay template that defines a plurality of different scenes based on choices made by users of the multiplayer interactive application, a first series of prompts corresponding to a first scene in the multiplayer interactive application;
providing, to a first user computing device of the plurality of different user computing devices executing the multiplayer interactive application and via a network, the first series of prompts, wherein the first user computing device is configured to provide each of the first series of prompts to the first user computing device as part of the first scene;
receiving, from the first user computing device and via the network, a first set of responses corresponding to the first series of prompts;
after receiving the first set of responses:
generating, based on the first set of responses and based on the gameplay template, a second series of prompts corresponding to the first scene in the multiplayer interactive application;
providing, to a second user computing device executing the multiplayer interactive application and via the network, the second series of prompts, wherein the second user computing device is configured to provide each of the second series of prompts to a second user as part of the first scene; and
receiving, from the second user computing device and via the network, a second set of responses corresponding to the second series of prompts;
selecting, from the plurality of different scenes defined by the gameplay template and based on the first set of responses and the second set of responses, a second scene; and
providing, to the first user computing device and the second user computing device and via the network, data corresponding to the second scene, wherein the first user computing device and the second user computing device are configured to provide, in the multiplayer interactive application, the second scene.

18. The method of claim 17, further comprising:
receiving, from one or more spectator computing devices and via the network, feedback data that indicates one or more reactions, by one or more users of the one or more spectator computing devices, to the first scene, wherein generating the second series of prompts is further based on the feedback data.

19. The method of claim 17, further comprising:
determining, based on the gameplay template, a third set of responses corresponding to a non-player character in the multiplayer interactive application, wherein generating the second series of prompts is further based on the third set of responses.

20. The method of claim 17, wherein providing, to the second user computing device executing the multiplayer interactive application, the second series of prompts comprises:
sending, to the first user computing device and via the network, a wait command configured to cause display, in the multiplayer interactive application executing on the first user computing device, a notification that a user of the first user computing device should wait on a second user of the second user computing device.
